(19) United States
(12) Patent Application Publication
(10) Pub. No.: US 2025/0338169 A1
(43) Pub. Date: Oct. 30, 2025

(54) METHOD AND APPARATUS FOR DELAY STATUS REPORTING IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/182,858

(22) Filed: Apr. 18, 2025

(30) Foreign Application Priority Data
Apr. 30, 2024 (KR) 1020240057611

(51) Int. Cl. H04W 28/02; H04L 1/1607

(52) U.S. Cl. CPC H04W 28/0278; H04L 1/1614

(57) ABSTRACT

A method and apparatus for XR services is provided. The method for supporting XR services includes receiving from a base station a RRCReconfiguration message that comprises a parameter for delay status report and transmitting to the base station a Medium Access Control (MAC) Control Element (CE) for delay status report in case that a specific condition is fulfilled for the specific LCG. The MAC CE comprises a bitmap related to a plurality of LCGs and delay status for the specific LCG. The delay status comprises a first set of delay status fields and a second set of delay status fields. The first set of delay status fields comprises a buffer size field indicating amount of a first set of data units. The second set of delay status fields comprises the buffer size field indicating amount of a second set of data units.

### CROSS-REFERENCE TO RELATED APPLICATION

This application claims priority to and the benefit of Korean Patent Application No. 10-2024-0057611, filed on Apr. 30, 2024, the disclosure of which is hereby incorporated herein by reference in its entirety.

### BACKGROUND

### Technical Field

The present disclosure relates to enhanced delay status reporting for extended reality in a mobile communication system.

### Related Art

To meet the increasing demand for wireless data traffic since the commercialization of 4th generation (4G) communication systems, the 5th generation (5G) system is being developed. For the sake of high, 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

Extended Reality (XR) refers to all real-and-virtual combined environments and human-machine interactions generated by computer technology and wearables. XR is an umbrella term for different types of realities.

During a XR service, huge amount of Data Bursts may be generated and transmitted over NR downlink and uplink. Data Burst of XR services often have stringent delay budget. It requires more sophisticated uplink scheduling technique to achieve timely scheduling and to avoid excessive resource waste.

### SUMMARY

Aspects of the present disclosure are to address the problems of XR traffic handling. The method for supporting XR services includes receiving from a base station a RRCReconfiguration message that comprises a parameter for delay status report and transmitting to the base station a Medium Access Control (MAC) Control Element (CE) for delay status report in case that a specific condition is fulfilled for the specific LCG. The MAC CE comprises a bitmap related to a plurality of LCGs and delay status for the specific LCG. The delay status comprises a first set of delay status fields and a second set of delay status fields. The first set of delay status fields comprises a buffer size field indicating amount of a first set of data units. The second set of delay status fields comprises the buffer size field indicating amount of a second set of data units.

### BRIEF DESCRIPTION OF THE DRAWINGS

FIG. 1 is a diagram illustrating the architecture of a 5G system and a NG-RAN.

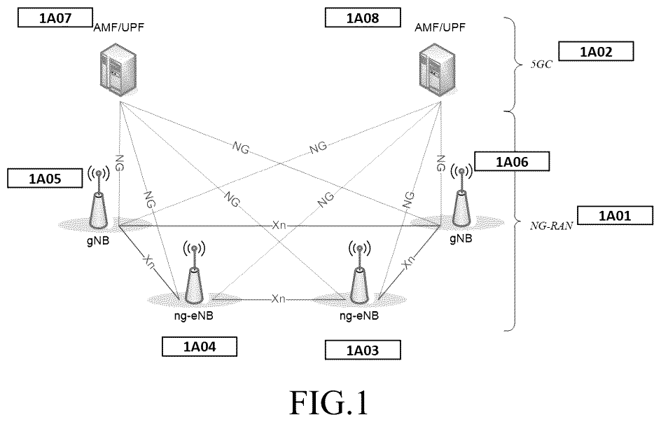

FIG. 2 is a diagram illustrating a wireless protocol architecture in a 5G system.

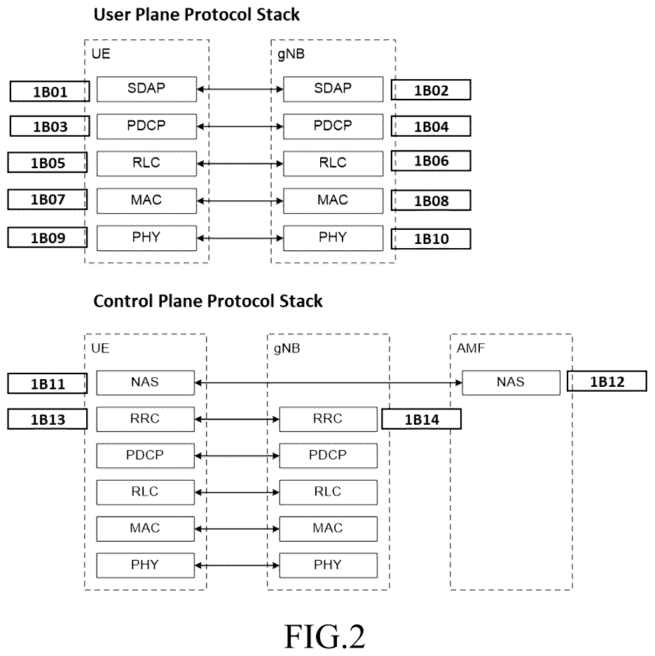

FIG. 3 illustrates overall operation of the UE and network.

FIG. 4 illustrates the operation of the UE regarding PLMN selection and cell selection and cell reselection.

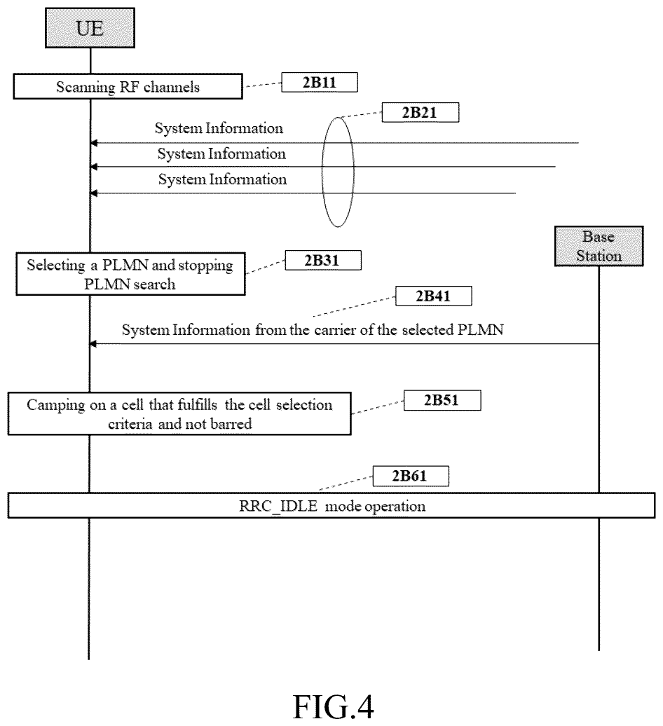

FIG. 5 illustrates RRC connection establishment procedure.

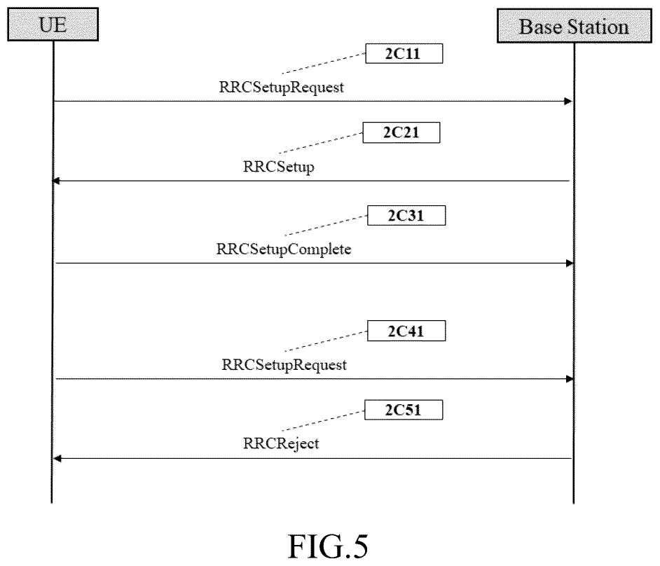

FIG. 6 illustrates UE capability transfer procedure.

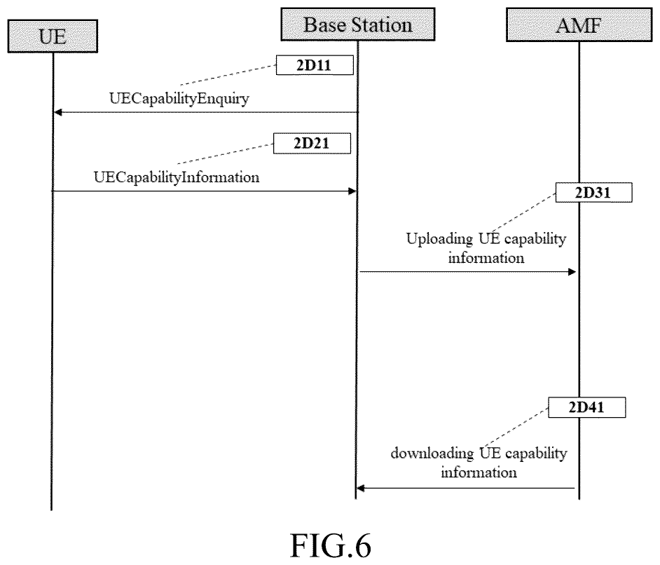

FIG. 7 illustrates RRC connection reconfiguration procedure.

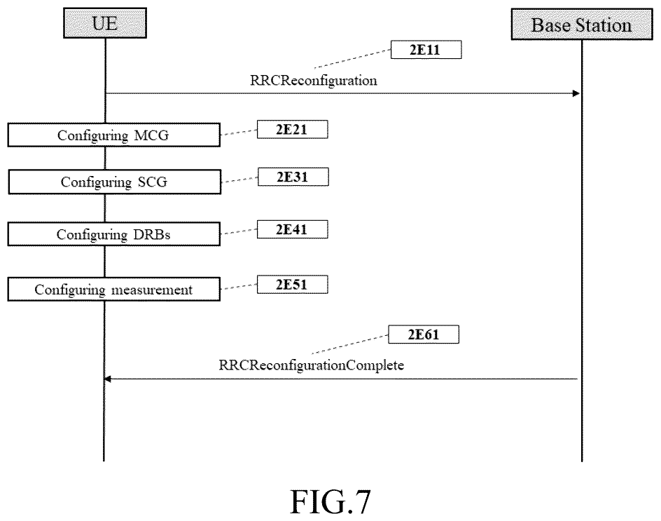

FIG. 8 illustrates data transfer procedure in RRC_CONNECTED state.

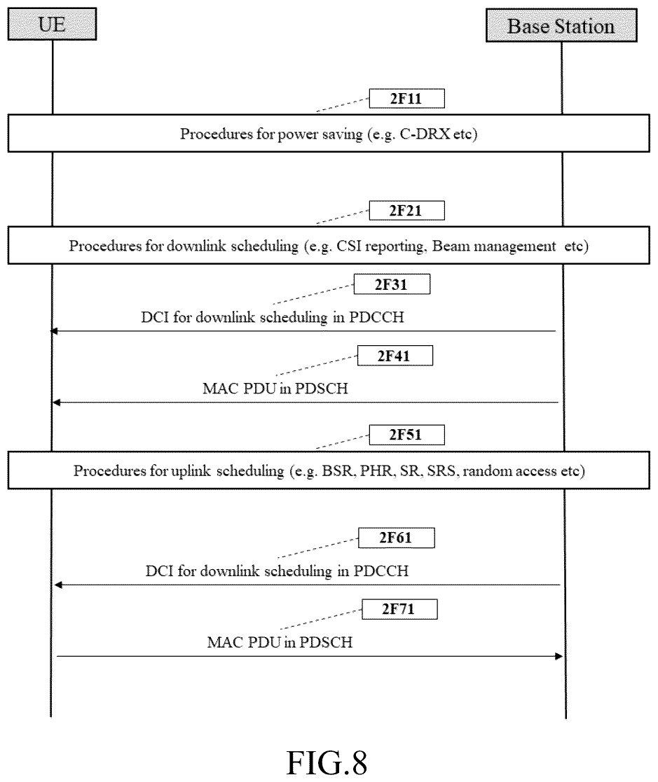

FIG. 9 illustrates random access procedure.

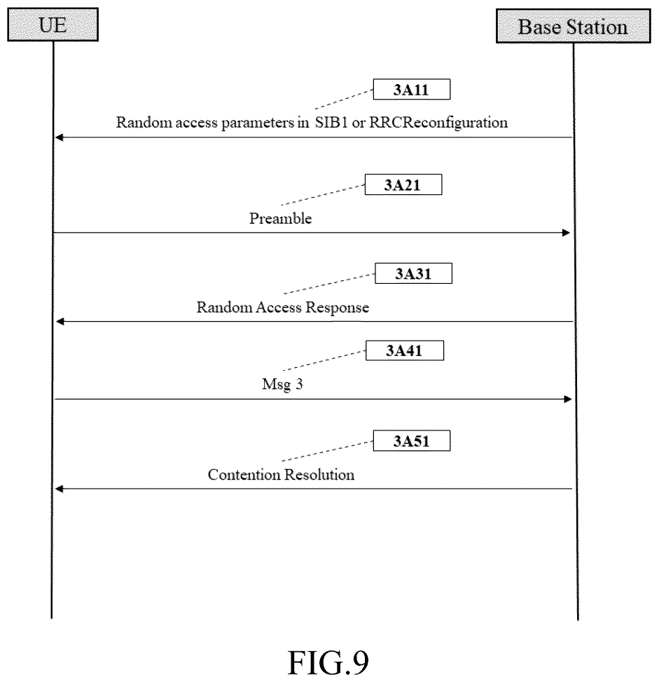

FIG. 10 illustrates scheduling request procedure based on dedicate scheduling request resource.

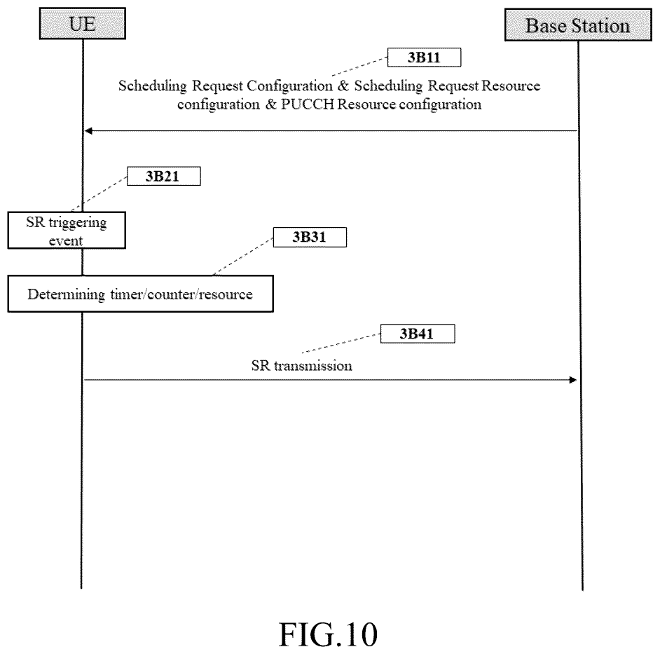

FIG. 11 illustrates buffer status reporting procedure.

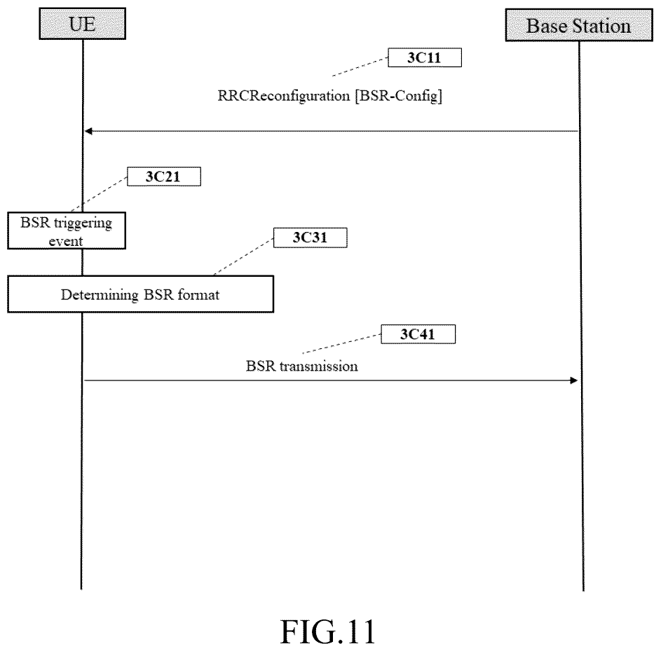

FIG. 12 illustrates MAC PDU format.

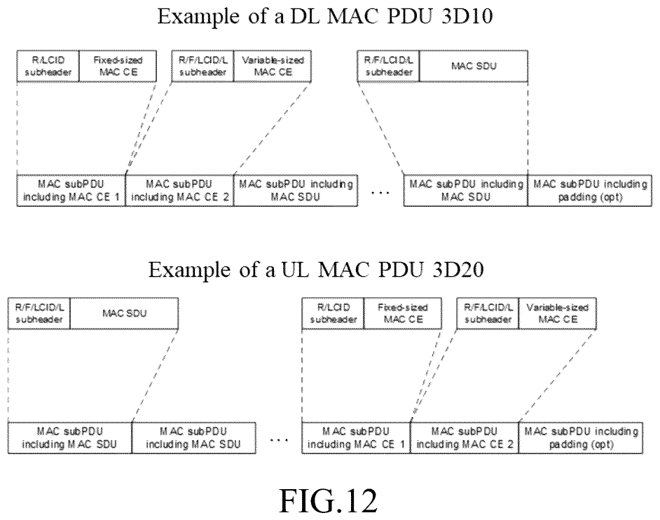

FIG. 13 illustrates MAC subheader format.

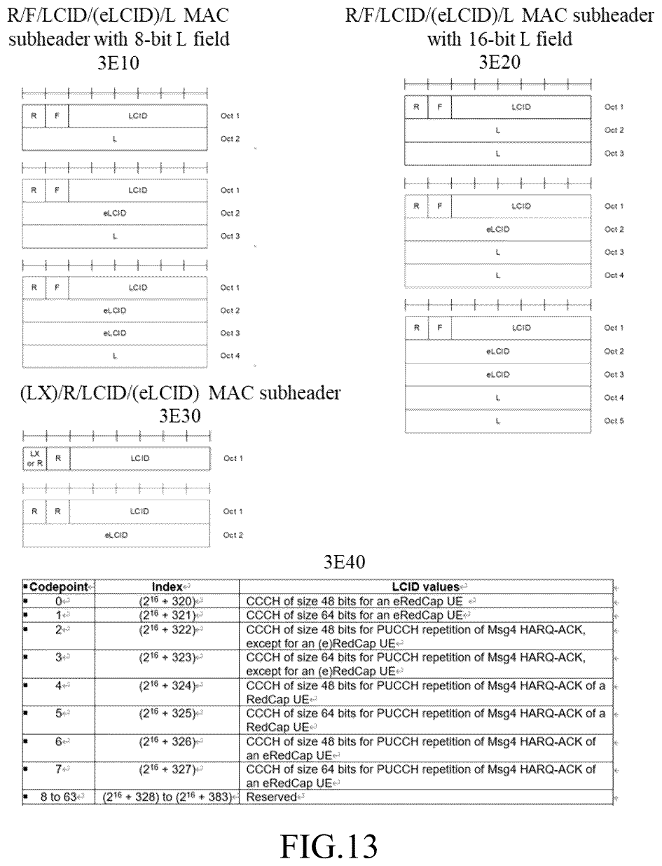

FIG. 14 is a diagram illustrating various formats of BSR.

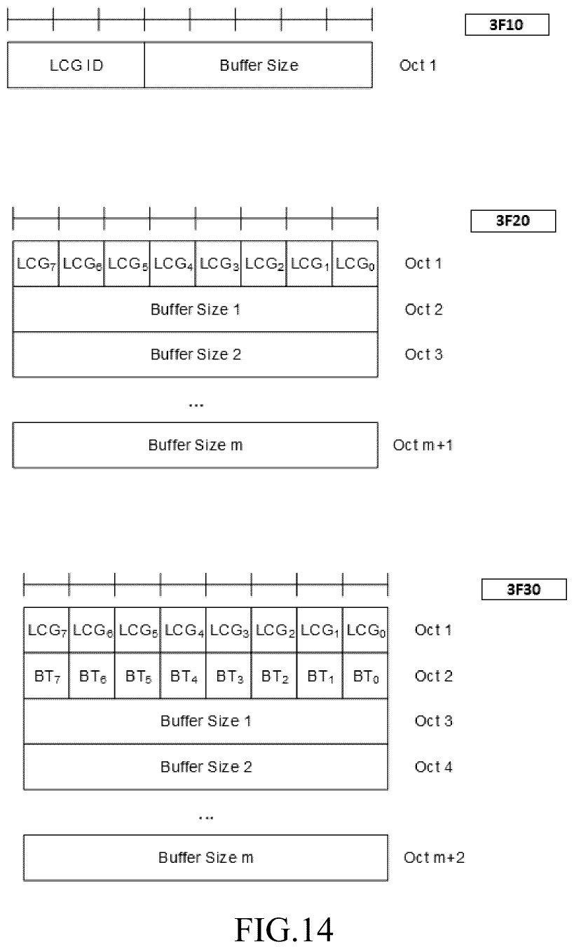

FIG. 15 is a diagram illustrating a format of DSR.

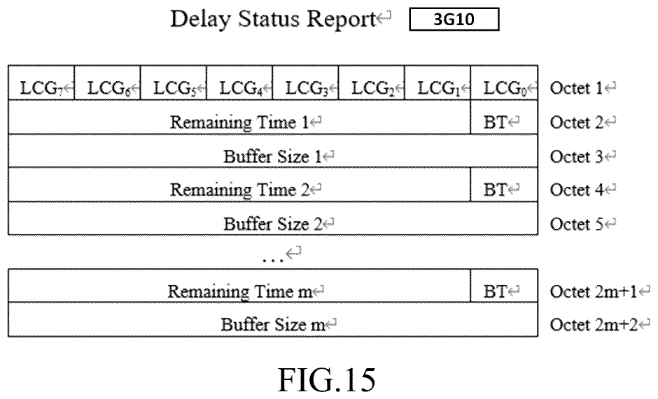

FIG. 16 is a diagram illustrating a format of extended DSR.

FIG. 17 is a diagram illustrating operations of the terminal and the base station for extended DSR reporting.

FIG. 18 is a diagram illustrating operations of the terminal.

FIG. 19 is a block diagram illustrating the internal structure of a UE to which the disclosure is applied.

FIG. 20 is a block diagram illustrating the configuration of a base station according to the disclosure.

### DETAILED DESCRIPTION

In the rapidly evolving landscape of wireless communication, Extended Reality (XR) applications, encompassing Augmented Reality (AR), Virtual Reality (VR), and Mixed Reality (MR), demand superior data handling capabilities to deliver seamless user experiences. The Buffer Status Reporting (BSR) mechanism in the MAC layer plays a pivotal role in ensuring efficient data transmission by reporting the status of buffers at the user equipment (UE) to the network. However, the traditional BSR mechanisms face challenges in meeting the low latency requirements critical for XR applications.

The present disclosure focuses on mitigating latency issues and ensuring robust connectivity, thereby enabling a seamless and responsive XR experience based on a new mechanism to report delay sensitive data to the base station. This solution aims to enhance data throughput, reduce latency, and improve overall network performance, thereby providing a more immersive and responsive XR experience.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE considers cell selection criterion S is fulfilled when:
Srxlev>0 AND
Squal>0
   where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE performs RRC_IDLE mode operation 2B61 such as monitoring control channels to receive system information and paging and notification message.

Successful RRC connection establishment procedure includes:
>1: transmission of RRCSetupRequest by the UE 2C11;
>1: reception of RRCSetup by the UE 2C21;
>1: transmission of RRCSetupComplete by the UE 2C31.

Unsuccessful RRC connection establishment procedure includes:
>1: transmission of RRCSetupRequest by the UE 2C41;
>1: reception of RRCReject by the UE 2C51;

RRCSetupRequest includes following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup includes following fields and IEs:
>1: radioBearerConfig field containing a RadioBearerConfig IE;
>1: masterCellGroup field containing a CellGroupConfig IE.

RRCSetupComplete includes following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRBO, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers.

For network to configure the UE with appropriate configurations, the network needs to know the capability of the UE. For this end, the UE and the base station perform UE capability transfer procedure.

UE capability transfer procedure consists of exchanging UECapabilityEnquiry 2D11 and UECapabilityInformation 2D21 between the UE and the base station.

In the UECapabiliityEnquiry, the base station indicates which RAT is subject to capability reporting. UE transmits the capability information for the requested RAT in the UECapability Information.

Once UECapabilityInformation is received, the capability information is uploaded to the AMF by the base station 2D31. When UE capability information is needed afterward, AMF provides it to the base station 2D41.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2E11 and RRCReconfigurationComplete 2E61 between the base station and the UE.

RRCReconfiguration may includes following fields and IEs:
>1: rrc-TransactionIdentifier field contains a RRC-TransactionIdentifier IE;
>1: radioBearerConfig field contains a RadioBearerConfig IE;
>>2: radioBearerConfig field includes configuration information for SRBs and DRBs via which RRC messages and user traffic are transmitted and received;
>1: secondaryCellGroup field contains a CellGroupConfig IE;
>>2: secondaryCellGroup field includes configuration information for secondary cell group;
>>2: A cell group consists of a SpCell and zero or more SCells;
>>2: Cell group configuration information includes cell configuration information for SpCell/SCell and configuration information for MAC and configuration information for logical channel etc;
>1: measConfig field contains a MeasConfig IE;
>>2: measConfig field includes configuration information for measurements that the

UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2E21;
>1: perform the cell group configuration for SCG based on the received secondaryCellGroup 2E31;
>1: perform the radio bearer configuration based on the received radioBearerConfig 2E41;
>1: perform the measurement configuration based on the received measConfig 2E51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31. The base station transmits to the UE PDSCH corresponding to the DCI and containing a MAC PDU 2F41.

The UE and the base station may perform various procedure for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

RRC connection release procedure includes:
>1: transmission of RRCRelease from the base station to the UE 2G11; and
>1: transmission of acknowledgement for the RRCRelease from the UE to the base station 2G21; and
>1: state transition from RRC_CONNECTED to either RRC_IDLE or RRC_INACTIVE 2G31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may include following fields for redirection:
>1: redirectedCarrierInfo field includes RedirectedCarrierInfo IE;
>>2: RedirectedCarrierInfo IE includes either CarrierInfoNR IE or RedirectedCarrierInfo-EUTRA IE;
>>>3: CarrierInfoNR IE includes ARFCN-ValueNR IE and SubcarrierSpacing IE;

The UE may perform cell selection on the carrier indicated by CarrierInfoNR IE or RedirectedCarrierInfo-EUTRA IE.

The RRCRelease may include following fields to configure cell reselection priority:
>1: cellReselectionPriorities field includes CellReselectionPriorities IE;
>>2: CellReselectionPriorities IE includes:
>>>3: FreqPriorityListNR IE;
>>>3: t320 field indicates a timer value for cell reselection priority validity;

During idle mode mobility, the UE applies the CellReselectionPriorities until T320 expires or stops.

The RRCRelease may include following fields/IEs to transition UE to RRC_INACTIVE state:
>1: suspendConfig field includes SuspendConfig IE;
>>2: fullI-RNTI field includes I-RNTI-Value IE;
>>2: shortI-RNTI field includes ShortI-RNTI-Value IE;
>>2: ran-PagingCycle field includes PagingCycle IE;
>>2: ran-NotificationAreaInfofield includes RAN-NotificationAreaInfo IE;
>>2: t380 field includes PeriodicRNAU-TimerValue;
>>2: nextHopChainingCount field includes NextHopChainingCount IE.
>>2: ran-ExtendedPagingCycle field includes ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
>1: delay the actions caused by RRCRelease 60 ms from the moment the RRCRelease message was received or optionally when lower layers indicate that the receipt of the RRCRelease message has been successfully acknowledged, whichever is earlier;
>1: store the cell reselection priority information provided by the cellReselectionPriorities and start T320;
>1: if the RRCRelease includes suspendConfig:
>>2: reset MAC and release the default MAC Cell Group configuration;
>>2: apply the received suspendConfig except the received nextHopChainingCount;
>>2: if the sdt-Config is configured:
>>>3: for each of the DRB in the sdt-DRB-List, consider the DRB to be configured for SDT;
>>>3: if sdt-SRB2-Indication is configured, consider the SRB2 to be configured for SDT;
>>>3: re-establish the RLC entity for each RLC bearer that is not suspended;
>>>3: trigger the PDCP entity to perform SDU discard for SRB1 and SRB2;
>>>3: if sdt-MAC-PHY-CG-Config is configured, configure the PCell with the configured grant resources for SDT and start the cg-SDT-TimeAlignmentTimer;
>>3: if srs-PosRRC-Inactive is configured, apply the configuration and instruct MAC to start the inactivePosSRS-TimeAlignmentTimer;
>>2: re-establish RLC entities for SRB1;
>>2: stop the timer T319 if running;
>>2: store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within Reconfiguration WithSync of the NR PSCell (if configured) and all other parameters configured except for:
>>>3: parameters within Reconfiguration WithSync of the PCell;
>>>3: parameters within Reconfiguration WithSync of the NR PSCell, if configured;
>>>3: parameters within MobilityControlInfoSCG of the E-UTRA PSCell, if configured;
>>>3: servingCellConfigCommonSIB;
>>2: suspend all SRB(s) and DRB(s) and multicast MRB(s), except SRB0 and broadcast MRBs;
>>2: indicate PDCP suspend to lower layers of all DRBs and multicast MRBs;
>>2: start timer T380, with the timer value set to t380;
>>2: indicate the suspension of the RRC connection to upper layers;
>>2: enter RRC_INACTIVE and perform cell selection;
>1: else (if the RRCRelease does not include suspendConfig):
>>2: perform the actions upon going to RRC_IDLE;

RRC connection resume procedure, in case of state transition from RRC_INACTIVE to RRC_CONNECTED, consists of RRC message exchange between the UE and the base station: RRCResumeRequest 2H11 and RRCResume 2H21 and RRCResumeComplete 2H31.

RRC connection resume procedure, in case of small data transmission without state transition, consists of RRC message exchange between the UE and the base station: RRCResumeRequest 2H41 and RRCRelease 2H51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for of RRCResumeRequest). Then UE transmits RRCResumeRequest 2H11 or 2H41 to the base station. The message includes the UE identifier which can be used by the base station to identify the UE context where RRC connection information of the UE is stored.

When the base station determines that UE needs to be in RRC_CONNECTED state, the base station transmits RRCResume. Upon reception of RRCResume 2H21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2H51. When the base station determines that small data transmission is finished, the base station transmits RRCRelease 2H61.

Random access procedure enables the UE to align uplink transmission timing, and indicate the best downlink beam, and transmit a MAC PDU that may contain CCCH SDU (e.g. RRCSetupRequest).

Random access procedure includes preamble transmission 3A21, random access response reception 3A31, Msg 3 transmission 3A41 and contention resolution 3A51.

Parameters for random access procedure are provided in SIB 1 (in case of initial access) or in RRCReconfiguration (in case of handover) 3A11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
>1: flush the buffer for Msg 3;
>1: initialize the counters for preamble transmission and power ramping;
>1: select the uplink carrier for performing the random access procedure based on a rsrp threshold (e.g. rsrp-ThresholdSSB-SUL);
>1: select the set of Random Access resources applicable to the current Random Access procedure;
>1: select a SSB based on a rsrp threshold (e.g. rsrp-ThresholdSSB); a SSB corresponds to a downlink beam;
>1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
>1: select a random access preamble randomly with equal probability from the random access preambles associated with the selected SSB and the selected random access preamble group;
>1: determine the next available PRACH occasion from the PRACH occasions corresponding to the selected SSB;
>1: determine the transmission power of the preamble;
>>2: preamble transmission power=pathloss+preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA
>1: transmit the preamble in the determined PRACH occasion with the determined transmission power;
>1; start ra-Response Window;
>1: monitor the PDCCH of the SpCell for Random Access Response(s) identified by the RA-RNTI while the ra-Response Window is running;
>1: receive Random Access Response contains a MAC subPDU with Random Access Preamble identifier corresponding to the transmitted preamble;
>1: process the received Timing Advanced Command and the received UL grant;
>1: transmit a Msg 3 based on the received UL grant;
>>2: Msg 3 may contain e.g. CCCH SDU such as RRCSetupRequest or RRCResumeRequest;
>1: start ra-ContentionResolutionTimer;
>1: monitor the PDCCH while the ra-ContentionResolutionTimer is running;
>1: consider Contention Resolution successful when MAC PDU containing a UE Contention Resolution Identity MAC CE is received;
>1: consider the Random Access procedure successfully completed.

Unlike downlink traffic, the scheduler in the base station does not know when UE needs to be scheduled for uplink transmission. To enable uplink scheduling, the UE can be configured with scheduling request resource. When uplink resource is required for the UE, the UE can transmit a one-bit signal on the scheduling request resource based on the scheduling request procedure.

The base station provides to the UE configuration information for dedicate scheduling request procedure in RRCReconfiguration 3B11.

The configuration information includes four main components: mapping information between events and the counter/timer/time resource/frequency resource, configuration information for counter/timer, configuration information for time resource, and configuration information for frequency resource.

One or more instances of configuration information on counter/timer (e.g. SchedulingRequestToAddMod) can be provided to the UE; each of them is associated with an identifier (e.g.schedulingRequestId). An initial value for counter (e.g. sr-TransMax) defines the number of consecutive times for SR transmission that is allowed. The timer (sr-Prohibittimer) defines the minimum time duration between the consecutive SR transmission.

One or more instances of configuration information on scheduling request resource (c.g. SchedulingRequestResourceConfig) can be provided to the UE; each of them is associated with an identifier (schedulingRequestID). The configuration information further includes time domain information for the resource (e.g. periodicityAndOffset) and the identifier of the associated timer/counter (schedulingRequestResourceld) and the identifier of the associated frequency domain resource (PUCCH-ResourceId).

One or more instances of configuration information on PUCCH resource (c.g. PUCCH-Resource) can be provided to the UE; each of them is associated with an identifier (c.g. PUCCH-Resourceld). The configuration information includes identifier of PRB where the PUCCH resource starts and an indication whether intra-slot frequency hopping is enabled.

The base station can indicate UE which counter/timer shall be used for which SR triggering event by binding the SR triggering event with a schedulingRequestId.

SR triggering event can be: data arrival in logical channel, SCell beam failure recovery, positioning measurement gap activation/deactivation request etc.

When an SR triggering event occurs 3B21, the UE determines the associated counter/timer based on the mapping information between SR triggering event and schedulingRequestId. Based on the determined schedulingRequestID, the UE determines the associated PUCCH-Resource and the associated SchedulingRequestResource 3B31; more specifically, the UE determines that the SchedulingRequestResource of which configuration information includes schedulingRequestID is the SchedulingRequestResource associated with the timer/counter identified by the schedulingRequestID.

The UE transmits the SR 3B41:
>1: in the time/frequency resource determined from SchedulingRequestResource associated with the schedulingRequestId; and
>1: based on the prohibit timer and the initial counter value determined from the schedulingRequestId.

SchedulingRequestToAddMod and SchedulingRequestResource have one to one relationship between them.

Unlike downlink traffic, the scheduler in the base station does not know when and how much and how important data arrives in the UE. To provide information on buffer status, the UE may transmit a Buffer Status Report (BSR) MAC CE when deemed triggered. BSR MAC CE includes one or more Buffer Size field, each of which indicates the amount of data available for transmission across logical channels of a logical channel group.

The base station provides a BSR configuration via a dedicate RRC message such as RRCReconfiguration 3C11. The BSR configuration includes a timer controlling periodic reporting and other information. The mapping information between a logical channel and a logical channel group is also provided in the dedicate RRC message.

BSR can be triggered event-driven or periodically or based on padding. Upon a significant event that cause buffer status change or upon expiry of a timer or upon space for padding being available, BSR is triggered 3C21.

A BSR shall be triggered if any of the following events occur for activated cell group:
>1: UL data, for a logical channel which belongs to an LCG, becomes available to the MAC entity; and either
>>2: this UL data belongs to a logical channel with higher priority than the priority of any logical channel containing available UL data which belong to any LCG; or
>>2: none of the logical channels which belong to an LCG contains any available UL data.
>1: in which case the BSR is referred below to as ‘Regular BSR’;
>1: UL resources are allocated and number of padding bits is equal to or larger than the size of the Buffer Status Report MAC CE plus its subheader, in which case the BSR is referred below to as ‘Padding BSR’;
>1: retxBSR-Timer expires, and at least one of the logical channels which belong to an LCG contains UL data, in which case the BSR is referred below to as ‘Regular BSR’;
>1: periodicBSR-Timer expires, in which case the BSR is referred below to as ‘Periodic BSR’.

The UE determines the format of the BSR depending on which event triggers the BSR 3C31.

Based on the number of logical channel groups with data available for transmission, a short format and a long format are defined.

Based on whether all logical channels can be reported or not, a truncated format and the normal/full format are defined.

Short BSR and Short Truncated BSR include following fields:
>1: LCG ID field indicates the identifier of LCG whose buffer status is being reported.
>1: short Buffer Size field indicates the total amount of data available across all logical channels of a logical channel group. The amount of data is indicated in number of bytes. The length of this field is 5 bit.

Long BSR and Long Truncated BSR includes following fields:
>1: Bitmap field includes 8 bit. Each bit indicates the presence of the Buffer Size field for the corresponding logical channel group;
>1: long Buffer Size field indicates the total amount of data available across all logical channels of a logical channel group. The amount of data is indicated in number of bytes. The length of this field is 8 bit.

In principle, since the information contained in BSR triggered due to new uplink data or timer expiry is crucial for uplink scheduling, BSR format is determined solely based on the number of LCGs for reporting. On the other hands, the information contained in BSR triggered due to padding is supplementary information for uplink scheduling, BSR format is determined based on the number of LCGs and the size of padding space.

The UE transmits a Short BSR in the following case:
>1: only one LCG has data available for transmission and the BSR is triggered due to new uplink data or timer expiry; or
>1: only one LCG has data available for transmission and the size of padding is enough to accommodate the Short BSR.

The UE transmits a Short Truncated BSR in the following case:
>1: padding occurs (e.g. MAC SDUs or MAC CEs do not fill up all the available space of MAC PDU); and
>1: more than one LCG have data available for transmission; and
>1: the size of padding is not enough to accommodate a Long BSR or a Long Truncated BSR but enough to accommodate the Short Truncated BSR.

The UE transmits a Long BSR in the following case:
>1: more than one LCGs have data available for transmission and the BSR is triggered due to new uplink data or timer expiry.

The UE transmits a Long Truncated BSR in the following case:
>1: padding occurs; and
>1: more than one LCG have data available for transmission; and
>1: the size of padding is not enough to accommodate a Long BSR but enough to a Long Truncated BSR.

The UE transmits BSR 3C41. To get the uplink resource for BSR transmission, if the BSR is triggered for new uplink data that is important than what are stored previously, scheduling request procedure can be initiated beforehand.

A MAC PDU is a bit string that is byte aligned (i.e. multiple of 8 bits) in length. Bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a MAC PDU is represented with the first and most significant bit in the leftmost bit and the last and least significant bit in the rightmost bit

A MAC SDU is a bit string that is byte aligned (i.e. multiple of 8 bits) in length. A MAC SDU is included into a MAC PDU from the first bit onward.

A MAC CE is a bit string that is byte aligned (i.e. multiple of 8 bits) in length.

A MAC subheader is a bit string that is byte aligned (i.e. multiple of 8 bits) in length. Each MAC subheader is placed immediately in front of the corresponding MAC SDU, MAC CE, or padding.

A MAC PDU consists of one or more MAC subPDUs. Each MAC subPDU consists of one of the following:
>: A MAC subheader only (including padding);
>: A MAC subheader and a MAC SDU;
>: A MAC subheader and a MAC CE; and
>: A MAC subheader and padding.

A DL MAC PDU 3D10 includes MAC subPDUs for MAC CE first and MAC subPDUs for MAC SDU next. An UL MAC PDU 3D20 includes MAC subPDUs for MAC SDU first and MAC subPDUs for MAC CE next. The difference is to ensure that UE have sufficient processing time for MAC SDUs (e.g. pre-processing).

Each MAC subheader corresponds to either a MAC SDU, a MAC CE, or padding.

A MAC subheader except for fixed sized MAC CE, padding, and a MAC SDU containing UL CCCH consists of the header fields R/F/LCID/(CLCID)/L 3E20. A MAC subheader for fixed sized MAC CE and padding consists of the header fields R/LCID/(eLCID) 3E10. A MAC subheader for a MAC SDU containing UL CCCH consists of the header fields (LX)/R/LCID 3E30.

MAC CEs are placed together. DL MAC subPDU(s) with MAC CE(s) is placed before any MAC subPDU with MAC SDU and MAC subPDU with padding. UL MAC subPDU(s) with MAC CE(s) is placed after all the MAC subPDU(s) with MAC SDU and before the MAC subPDU with padding in the MAC PDU.

The MAC subheader consists of the following fields:
>LCID: The Logical Channel ID field identifies the logical channel instance of the corresponding MAC SDU or the type of the corresponding MAC CE or padding. There is one LCID field per MAC subheader. The size of the LCID field is 6 bits. If the LCID field is set to 34, one additional octet is present in the MAC subheader containing the eLCID field and follow the octet containing LCID field. If the LCID field is set to 33, two additional octets are present in the MAC subheader containing the eLCID field and these two additional octets follow the octet containing LCID field;
>eLCID: The extended Logical Channel ID field identifies the logical channel instance of the corresponding MAC SDU or the type of the corresponding MAC CE. The size of the eLCID field is either 8 bits or 16 bits.
>L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
>F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
>LX: The LCID extension field indicates the use of extended LCID space. The size of the LX field is 1 bit. The LX field set to 1 indicates the use of table 3E40, otherwise R bit is present instead (i.e. set to 0);

The MAC subheader is octet aligned.

Buffer Status Report (BSR) MAC CEs consist of either:
>: Short BSR format (fixed size) 3F10; or
>: Long BSR format (variable size) 3F20; or
>: Refined BSR format (variable size) 3F30.

The BSR formats are identified by MAC subheaders with LCIDs.

The Refined BSR format is identified by MAC subheaders with eLCID.

The fields in the BSR MAC CE are defined as follows:
>: LCG ID: The Logical Channel Group ID field identifies the group of logical channel(s) whose buffer status is being reported. The length of the field is 3 bits for the case of Short BSR and Short Truncated BSR formats, and 8 bits for the case of Extended Short BSR and Extended Short Truncated BSR formats;
>: LCGᵢ: this field indicates the presence of the Buffer Size field for logical channel group i. The LCGᵢ field set to 1 indicates that the Buffer Size field for the logical channel group i is reported. The LCGᵢ field set to 0 indicates that the Buffer Size field for the logical channel group i is not reported;
>: BTᵢ: this field indicates which buffer size table is used to encode the buffer size of the logical channel group i. The BTᵢ field set to 1 indicates that the third buffer size table is used for the logical channel group i. The BTᵢ field set to 0 indicates that the second buffer size table is used for the logical channel group i or the buffer size table is not used for the logical channel group i. UE sets the BTi field to 0 if LCGi field is 0. The UE sets the BTi field based on the total amount of data of LCGi available for transmission if LCGi field is 1.
>: Buffer Size: The Buffer Size field identifies the total amount of data available according to the data volume calculation procedure across all logical channels of a logical channel group after the MAC PDU has been built (i.e. after the logical channel prioritization procedure, which may result the value of the Buffer Size field to zero). The size of the RLC headers and MAC subheaders are not considered in the buffer size computation. For refined BSR format, if the amount of data for an LCG is within the closed range of the buffer sizes specified in the third table, the MAC entity shall use the third BSR table to set the value of this field. Otherwise, the MAC entity shall use the second BSR table. The amount of data in this field is indicated in number of bytes. The length of this field is 5bit (in case of short BSR format) or 8 bits (in case of long BSR format or refined BSR format). The Buffer Size fields are included in ascending order based on the LCGi.

The Delay Status Report (DSR) MAC CE 3G10 is identified by MAC subheader with an eLCID.

The fields in the DSR MAC CE are defined as follows:
>: LCGᵢ: This field indicates the presence of delay information (i.e. the BT field and the Remaining Time and Buffer Size fields) for the LCG i. The LCGᵢ field set to 1 indicates that the delay information for the LCG i is reported. The LCGᵢ field set to 0 indicates that the delay information for the LCG i is not reported; UE includes the delay information for the LCG which is:
>>: configured for delay status reporting; and/or
>>: the smallest remaining value of PDCP discardTimers of all SDUs of all logical channels of the LCG is smaller than (below) remaining TimeThreshold. (LCG that have at least one delay-critical PDCP SDU);
>: BT: This field indicates which buffer size table is used to encode the buffer size of the associated logical channel group (e.g. the buffer size field in the next octet, or the buffer size field that follows Remaining time field that follows BT field);
>: Remaining time: This field indicates the shortest remaining value of PDCP discardTimer among all PDCP SDUs buffered for an LCG, at the time of the first symbol of the first PUSCH transmission that includes this DSR MAC CE. It is 7 bit. 0 (first value/index/code point) indicates 0˜1 ms, 1 indicates 1˜2 ms, 126 indicates 126˜127 ms and 127 (last value/index/code point) indicates shortest remaining value is above 127 ms;
>: Buffer Size: The Buffer Size field indicates the total amount of delay-critical UL data for an LCG according to the data volume calculation procedure for the associated PDCP and RLC entities, respectively after the MAC PDU has been built (after logical channel prioritization procedure). This field is indicated in bytes. The length of this field is 8 bits.

The reference time point of Remaining time field (which is at the time of the first symbol of the first PUSCH transmission that includes this DSR MAC CE) and the reference time point of Buffer Size field (according to the data volume calculation across all logical channels of a logical channel group after the MAC PDU has been built (i.e. after the logical channel prioritization procedure, which may result the value of the Buffer Size field to zero)) is different. It may increase UE complexity but enhance the usefulness of the information.

The Remaining Time field, the BT field, and the Buffer Size field for an LCG shall be reported in two consecutive octets. These three fields for different LCGs shall be included in a DSR MAC CE in ascending order based on the LCGi.

Extended Reality (XR) is an umbrella term that encompasses Virtual Reality (VR), Augmented Reality (AR), and Mixed Reality (MR). These immersive technologies merge the physical and digital worlds, enabling users to interact with virtual environments in ways that feel natural and intuitive. XR creates transformative experiences by blending real-world elements with digital enhancements, offering applications across industries such as entertainment, healthcare, education, and manufacturing.

Integrating XR services with NR (New Radio) enables seamless and high-performance connectivity for immersive experiences. NR's ultra-low latency and high-speed data transmission capabilities ensure real-time interactions in XR applications, enhancing user engagement and reducing motion sickness. This combination unlocks new possibilities for XR, such as advanced remote collaboration, immersive gaming, and enhanced industrial training scenarios.

For XR services, PDU Set based traffic handling is required where a group of packets forming a PDU Set are handled based on the same delay budget. A PDU Set is useless if all the packets of the PDU Set are not delivered to the receiving device within the delay budget (e.g. a single packet crossing the delay budget results in loss of all packets of the PDU Set).

In wireless mobile communication systems like NR, uplink traffic is scheduled by base station based on the scheduling assistance data like Buffer Status Report (BSR) or Delay Status Report (DSR) sent by the terminal. Delay Status Report is especially important for XR traffic handling due to collective treatment for a PDU Set. Scheduler in the base station needs to know how much data is about to exceed delay budget.

Depending on UE capability and QoS requirements of XR traffic, level of details on the delay status should strike the balance between overhead size and scheduling efficiency. In this disclosure, two types of delay status reporting are considered. Base station may configure the UE with a proper type of delay status reporting.

TABLE 1

| | Delay Status Report MAC CE | Extended Delay Status Report MAC CE |
|---|---|---|
| Purpose | To report delay-critical UL data | To report delay-critical UL data and |
| | | to-be-delay-critical UL data |
| Format | One or more baseline delay information | One or more baseline delay information |
| | triplets for one or more LCGs | triplets for one or more LCGs; |
| | | One or more additional delay information |
| | | triplets for a LCG |
| Configured | A specific list in RRC message | A second specific list in RRC message |
| by | | |
| Released | A third specific list (dsr- | A third specific list in RRC message |
| by | ConfigToReleaseList) in RRC message | |
| Configured | Per LCG | Per LCG |
| for | | |
| Triggered | Per LCH | Per LCH |
| for | | |
| Reported | UL data buffered across LCHs of LCG | UL data buffered across LCHs of LCG |
| for | | |

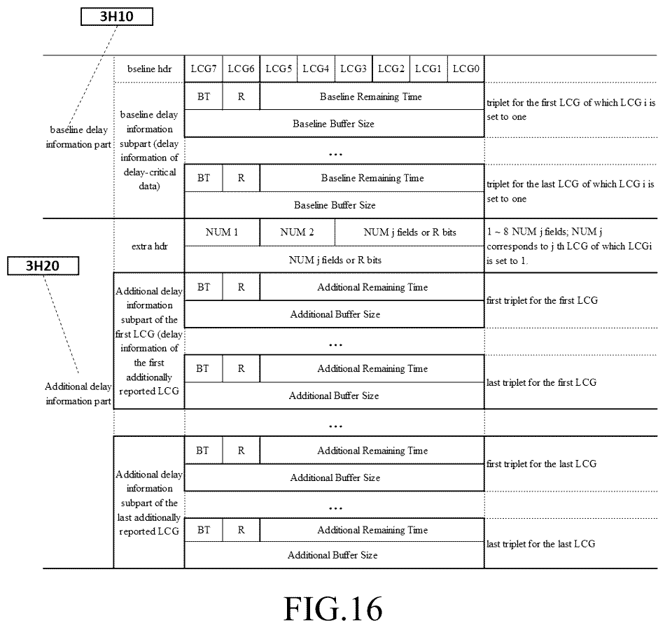

FIG. 16 illustrates the format of extended DSR.

The Extended Delay Status Report (DSR) MAC CE is identified by MAC subheader with an eLCID.

The fields in the Extended DSR MAC CE are defined as follows:
>: Baseline delay information part 3H10 includes a baseline a header subpart and a baseline delay information subpart:
>>: Baseline header subpart includes one octet bitmap that contains 8 LCGi bits.
>>>: LCGi: This field indicates the presence of delay information triplet (i.e. BT and the Remaining Time and Buffer Size fields) for the LCG i. The LCGi field set to 1 indicates that the delay information for the LCG i is reported. The LCGi field set to 0 indicates that the delay information for the LCG i is not reported;
>>: Baseline delay information subpart includes one or more delay information triplets.
>>>: Each of one or more delay information triplets corresponds to a LCG.
>>>>: The first triplet corresponds to first reported LCG. The first reported LCG is first LCG of which LCG i is set to 1.
>>>>: The second triplet corresponds to second reported LCG. The second reported LCG is second LCG of which LCG i is set to 1.
>>>>: And so on until the last triplet that corresponds to last reported LCG. The last reported LCG is last LCG of which LCG i is set to 1.
>>>>: Number of triplets is equal to number of reported LCGs.
>>>>: Reported LCG is LCG of which LCG i is set to 1.
>>>: Each of one or more delay information triplets in the baseline header subpart indicates delay status of delay-critical data buffered in LCHs of corresponding LCG.
>: Additional delay information part 3H20 includes an extra header subpart and one or more additional delay information subparts.
>>: Extra header subpart includes one or more NUM fields and zero or more R bits.
>>>: Each of one or more NUM fields corresponds to a LCG.
>>>>: The first NUM field indicates number of delay information triplets of the first reported LCG.
>>>>: The second NUM field indicates number of delay information triplets of the second reported LCG.
>>>>: And so on until the last NUM field that indicates number of delay information triplets of the last reported LCG.
>>>>: For example,
>>>>>: if the second NUM field is set to 10, the number of additional delay information triplets of the second reported LCG is 2 (e.g. two additional delay information triplets in addition to baseline delay information triplet are reported for the LCG);
>>>>>: if the last NUM field is set to 11, the number of additional delay information triplets of the last reported LCG is 3 (e.g. two additional delay information triplets in addition to baseline delay information triplet are reported for the LCG);
>>>>: Number of NUM fields is equal to number of reported LCGs
>>>: Size of the extra header subpart is determined based on number of NUM fields.
>>>>: If number of NUM fields=<4, extra header subpart is 1 byte.
>>>>: If number of NUM fields>4, extra header subpart is 2 bytes.
>>: The first additional delay information subpart includes one or more additional delay information triplets of the first additionally reported LCG.
>>: The second additional delay information subpart includes one or more additional delay information triplets of the second additionally reported LCG.
>>: And so on until the last additional delay information subpart that includes one or more additional delay information triplets of the last additionally reported LCG.
>>: Additionally reported LCG is LCG of which NUM field indicates non-zero.
>>: Number of additional delay information subpart is equal to number of additionally reported LCGs.
>>: Each of one or more delay information triplets in the additional header subpart indicates delay status of non delay-critical data buffered in LCHs of corresponding LCG.

### Baseline Delay Information Triplet

Baseline delay information triplet is present either in case that Baseline Buffer Size field is not to zero or in case that Baseline Buffer field is set to zero.
>: Remaining Time of delay-critical data (e.g. baseline remaining time for delay critical PDU Set): This field indicates the shortest remaining value of running PDCP discardTimer among all PDCP SDUs that are buffered for an LCG but have not been transmitted in any MAC PDU, at the time of the first symbol of the first PUSCH transmission that includes this extended DSR MAC CE. The length of this field is 6 bits. This field is present only if the buffer size indicated by the corresponding Buffer Size field is not zero; otherwise, this field is reserved and set to 0. If present, the value r in this field indicates a remaining time within the range of [r, r+1] msec;
>: BT: This field is present only if the corresponding LCG is configured with additionalBS-TableAllowed and the buffer size indicated by the corresponding Buffer Size field is not zero; otherwise, this field is reserved and set to 0. If present, the BT field set to 1 indicates that the buffer sizes specified in second buffer size table are used to set the value of the Baseline Buffer Size field, while the BT field set to 0 indicates that the buffer sizes specified in first buffer size table are used instead;
>: Baseline Buffer Size: The Baseline Buffer Size field indicates the total amount of delay-critical UL data for an LCG according to the data volume calculation procedure for the associated RLC and PDCP entities, respectively, after the MAC PDU (that contains this extended DSR MAC CE) has been built. If the corresponding LCG is configured with additionalBS-TableAllowed and the amount of delay-critical UL data for an LCG is within the buffer sizes specified in the second table, the MAC entity shall use the buffer sizes specified in second table to set the value of this field; otherwise, the MAC entity shall use first table instead. This field is indicated in number of bytes. The length of this field is 8 bits.

### Additional Delay Information Triplet

Additional delay information triplet is present in case that Buffer Status to be reported in Additional Buffer Size field is not zero. Additional delay information triplet is not present in case that Buffer Status to be reported in Additional Buffer Size field is zero (e.g. no buffered data for this additional delay information triplet).
>: Remaining Time of non delay-critical PDU Set (e.g. additional remaining time): This field indicates the shortest remaining value of running PDCP discardTimer among all PDCP SDUs of a specific PDU Set that are buffered for an LCG but have not been transmitted in any MAC PDU, at the time of the first symbol of the first PUSCH transmission that includes this extended DSR MAC CE. The length of this field is 6 bits. This field is present only if the buffer size indicated by the corresponding Buffer Size field is not zero; otherwise, this field is reserved and set to 0. If present, the value r in this field indicates a remaining time within the range of [r, r+1] msec;
>>: The specific PDU Set is reported-non-delay-critical PDU Set (buffered in LCHs of the LCG) with n-th shortest remaining value in case that this additional delay information triplet is n-th entry for this additional delay information subpart of the LCG.
>>: reported-non-delay-critical PDU Set is a PDU Set that fulfils following conditions:
>>>: PDU Set that includes no delay-critical PDCP SDU; and
>>>: shortest remaining value of running PDCP discardTimer among all PDCP SDUS of the PDU Set is less than remaining TimeThresholdRep.
>: BT: This field is present only if the corresponding LCG is configured with additionalBS-TableAllowed. otherwise, this field is reserved and set to 0. If present, the BT field set to 1 indicates that the buffer sizes specified in second table are used to set the value of the Additonal Buffer Size field, while the BT field set to 0 indicates that the buffer sizes specified in first table are used instead;
>: Additional Buffer Size: The Additional Buffer Size field indicates the total amount of the specific PDU Set for the LCG according to the data volume calculation procedure for the associated RLC and PDCP entities, respectively, after the MAC PDU (that contains this extended DSR MAC CE) has been built. If the corresponding LCG is configured with additionalBS-TableAllowed and the specific PDU Set for an LCG is within the buffer sizes specified in second table, the MAC entity shall use the buffer sizes specified in second table to set the value of this field; otherwise, the MAC entity shall use first table instead. This field is indicated in number of bytes. The length of this field is 8 bits.

The extended DSR MAC CE shall include delay information of all LCGs comprising at least one LCH which has pending extended DSRs when the MAC PDU containing this extended DSR MAC CE is to be built.

The baseline delay information triplet for an LCG shall be reported in two consecutive octets. The baseline delay information triplets for different LCGs shall be included in the baseline delay information part of the extended DSR MAC CE in ascending order of LCGi.

Each of the additional delay information triplets for an LCG shall be reported in two consecutive octets. The additional delay information triplets for an LCGs shall be included in the additional delay information part of the extended DSR MAC CE in ascending order of shortest remaining value of discardTimers of the associated PDU Set.

Extended DSR is transmitted in case that:
>>>>: the smallest remaining value of the running PDCP discardTimers among all the SDUs buffered for the LCH that have not been transmitted in any MAC PDU and have not been reported as (delay-critical) data volume (in baseline delay information part) in an extended DSR MAC CE becomes below remainingTime Threshold of the LCG;
>>>>: there is no extended DSR pending for any LCH of the LCG (or if there is no extended DSR pending for a LCH of the LCG that are configured with the higher LCP than the LCH); and
>>>>: there is at least one LCG that has at least one additional delay information triplet to be reported (included in the MAC CE)

DSR (instead of extended DSR) is transmitted in case that:
>>>>: the smallest remaining value of the running PDCP discardTimers among all the SDUs buffered for the LCH that have not been transmitted in any MAC PDU and have not been reported as (delay-critical) data volume (in baseline delay information part) in an extended DSR MAC CE becomes below remaining TimeThreshold of the LCG;
>>>>: there is no extended DSR pending for any LCH of the LCG (or if there is no extended DSR pending for a LCH of the LCG that are configured with the higher LCP than the LCH); and
>>>>: there is no LCG that has at least one additional delay information triplet to be reported (included in the MAC CE) e.g. all the delay information triplets are included in the baseline delay information part.

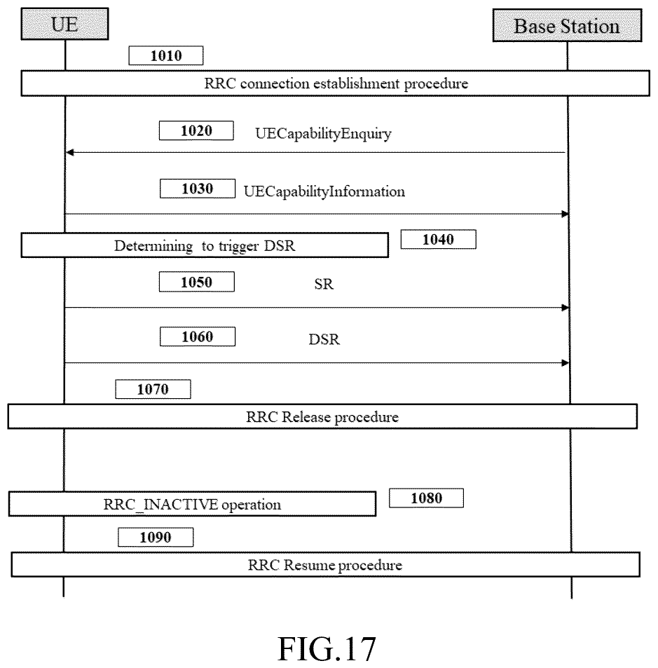

FIG. 17 illustrates signaling sequence between UE and GNB w.r.t delay status report.

At 1010, UE performs with GNB RRC connection establishment procedure to establish a SRB1.

At 1020, UE receives UECapabilityEnquiry and transmits UECapabilityInformation via the SRB1. UE CapabilityInformation may include two parameters.
>: First parameter indicating that UE supports delay status report of the buffered delay-critical data; and
>: Second parameter indicating that UE supports extended delay status report of the buffered delay-critical data and non-delay-critical data.

At 1030, UE receives RRC Reconfiguration message. GNB determines configurations for the UE based on reported capability and cell status. GNB transmits to UE RRCReconfiguration to deliver the determined configurations.

RRCReconfiguration may include DSR related parameter set or extended DSR related parameter set. UE configures DSR or extended DSR. UE configures radio bearers, logical channels and logical channel groups. UE configures scheduling request configurations.

At 1040, UE determines whether DSR or Extended DSR is triggered based on <Delay Status Reporting>and <Extended Delay Status Reporting>.

At 1050, UE performs SR transmission. When specific conditions as specified in <Scheduling Request>are fulfilled, UE triggers a SR for DSR or for extended DSR.

At 1060, UE performs (Extended) DSR transmission.

UE generates a (extended) DSR MAC CE. UE determines whether to include the (extended) DSR MAC CE in the MAC PDU. UE transmits the MAC PDU.

At 1070, RRCRelease procedure is performed.

GNB decides to release RRC connection and to change the state of RRC connection from RRC_CONNECTED to RRC_INACTIVE. UE and GNB perform relevant operations.

At 1080UE performs RRC_INACTIVE operation.

At 1090, RRC Resume procedure is performed.

When UE decides to resume the RRC connection, UE applies the default MAC Cell Group configuration before transmission of RRCResumeRequest.

UE releases extended DSR configuration. UE transmits RRCResumeRequest.

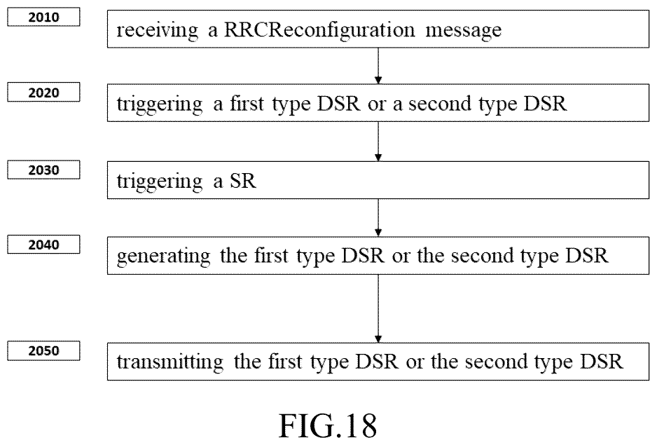

FIG. 18 illustrates UE operations.

At 2010, UE receives RRCReconfiguration message.

At 2020, UE triggers a first type DSR or a second type DSR.

At 2030, UE triggers a SR for the first type DSR or the second type DSR.

At 2040, UE generates the first type DSR or the second type DSR.

At 2050, UE transmits the first type DSR or the second type DSR.

UE may decide to trigger an extended delay status report for a logical channel in case that:
>: Logical channel group that the logical channel (LCH) belongs to is configured for extended DSR;
>: Smallest remaining value of discardTimers of specific set of PDCP SDUs (associated with the LCH) becomes below remainingTimeThreshold of the LCG; and
>: There is no extended DSR pending for a specific LCH.

The extended DSR includes:
>: A bitmap, wherein each bit of the bitmap corresponds to LCG;
>: One or more first field sets [baseline triplet], wherein each of the one or more first field sets is related to delay status of each LCG of the one or more LCGs;
>: One or more first fields [NUM], wherein each first field of the one or more first fields corresponds to LCG, wherein the mapping between a first field and a LCG is determined based on values of the bitmap;
>: each second field set of the one or more second field sets is related to delay status of LCG of the one or more LCGs
wherein number of the one or more first field sets is determined based on number of bits in the bitmap set to a specific value,
wherein number of the one or more second field sets for a LCG is determined based on number of specific PDU Sets stored in LCHs of the LCG.
wherein the specific PDU Sets include one or more PDU Sets of which smallest remaining value of discardTimers of the associated PDCP SDUs is smaller than remaing Time ThresholdRep of the LCG.

wherein number of the one or more second field sets is determined based on each of the one or more first fields.
wherein a first field set of a LCG includes:
>: remaining time field indicating the shortest remaining value of discardTimer among specific PDCP SDUs, wherein the specific PDCP SDUs includes one or more PDCP SDUs that are buffered in logical channels that belong to the LCG and that have not been transmitted;
>: Buffer Size field indicating the total amount of delay-critical UL data in radio bearers associated with LCG.
>>: A logical channel and a radio bearer are associated with each other in case that the logical channel is configured to serve the radio bearer
>>: A radio bearer and a LCG are associated with each other in case that a logical channel associated with the radio bearer belong to the LCG;
>: BT field indicating buffer size table that are used for determining value to be indicated in the Buffer Size field.
wherein a second field set of a LCG includes:
>: remaining time field indicating the shortest remaining value of discardTimer for a specific PDU Set that does not include delay-critical PDCP SDU, wherein the specific PDU Set includes one or more PDCP SDUs that are buffered in logical channels that belong to the LCG and that have not been transmitted and of which discardTimer is more than remaingTimeThreshold and less than remaingTimeThresholdRep;
>: Buffer Size field indicating the total amount of the specific PDU Set, wherein the specific PDU Set is stored in one or more radio bearers associated with the LCG;
>: BT field indicating buffer size table that are used for determining value to be indicated in the Buffer Size field.

The UE cancels the extended DSR in case that:
>: all the SDUs associated with the extended DSR have been discarded; or
>: a MAC PDU is transmitted and this MAC PDU includes an extended DSR MAC CE that contains the delay information of all the SDUs associated with the extended DSR.

The UE cancels the extended DSR in case that:
>: a MAC PDU is transmitted; and
>: this MAC PDU includes all the SDUs associated with the extended DSR but is not sufficient to include the extended DSR MAC CE and its subheader.

UE triggers a scheduling request in case that:
>: UL-SCH resources are available for a new transmission;
>: the UL-SCH resources are not enough accommodate the extended DSR MAC CE plus its subheader as a result of logical channel prioritization; and
>: there is no pending SR already triggered by the extended DSR procedure for any logical channel with higher LCP than the LCH

UE performs the followings for SR.
>: UE determines SR configuration for the extended DSR based on the LCH that triggered the extended DSR;
>: UE transmits SR based on the determined SR configuration;
>: UE cancels SR in case that:
>>: all the SDUs associated with the extended DSR have been discarded; or
>>: a MAC PDU is transmitted and this MAC PDU includes an extended DSR MAC CE that contains the delay information of all the SDUs associated with the extended DSR.

UE may perform the following.
>: UE decides to trigger SR for extended DSR;
>: UE determines SR configuration for the extended DSR based on the LCH that triggered the extended DSR;
>: UE decides to initiate a random access procedure on the SpCell in case that there is no valid PUCCH resource configured for the pending SR;
>: UE cancels the triggered SR;
>: UE stops the random access procedure on the SpCell in case that
>>: a MAC PDU is transmitted using a UL grant other than a UL grant provided by Random Access Response or a UL grant determined for the transmission of the MSGA payload, and this PDU includes either an extended DSR MAC CE or all the PDCP SDUs associated with the extended DSR; or
>>: all the PDCP SDUs associated with the extended DSR have been discarded. The extended configuration is released explicitly/individually or implicitly/collectively.

UE releases extended DSR configuration for a LCG upon reception of information indicating LCG ID in RRC message.

UE releases extended DSR configuration of all LCGs after initiating RRC connection resume and before transmitting RRCResumeRequest message.

Using the implicit/collective method is to prevent extended DSR is triggered before the RRCResumeRequest message is generated which may deteriorate transmission quality of RRCResumeRequest message (since extended DSR and RRCResumeRequest may transmitted in a single MAC PDU).

For implicit/collective release, UE performs followings:
>: UE receives configuration parameters for extended DSR;
>: UE performs extended DSR related operations;
>: UE receives a RRC message [RRCRelease] instructing state transition from RRC_CONNECTED to RRC_INACTIVE;
>: UE stores configuration parameters for extended DSR;
>: UE release the extended DSR and discarding the configuration parameters for extended DSR before transmitting a RRC message [RRCResumeRequest] requesting state transition from RRC_INACTIVE to RRC_CONNECTED;
>: UE transmits the RRC message

Different (one-octet) eLCIDs are used to indicate DSR and extended DSR (e.g. code point 228 for DSR and 218 for extended DSR).

### Delay Status Reporting

The Delay Status Reporting (DSR) procedure is used to provide the serving gNB with delay status of LCGs. This delay status for an LCG includes remaining time, which is the smallest remaining value of the running PDCP discardTimers among SDUs that are buffered for the LCG but have not been transmitted in any MAC PDU, and the total amount of delay-critical UL data for the LCG according to the data volume calculation procedurefor the associated RLC and PDCP entities, respectively.

RRC controls the DSR procedure by configuring the following parameter:
>: remainingTimeThreshold (per LCG): the threshold on remaining time for triggering a DSR for a LCH of the corresponding LCG.

If an LCG is configured for delay status reporting, the MAC entity shall for each LCH of the LCG:
>: if the smallest remaining value of the running PDCP discardTimer among all the PDCP SDUs buffered for the LCH that have not been transmitted in any MAC PDU and have not been reported as data volume in a DSR MAC CE becomes below remainingTimeThreshold of the LCG; and
>: if there is no DSR pending for the LCH:
>>: trigger a DSR for the LCH.

If there is at least one DSR pending, the MAC entity shall:
>: if UL-SCH resources are available for a new transmission and the UL-SCH resources can accommodate the DSR MAC CE plus its subheader as a result of logical channel prioritization:
>>: instruct the Multiplexing and Assembly procedure to generate the DSR MAC CE.
>: else if there is no pending SR already triggered by the DSR procedure for any logical channels of LCG that the first LCH belongs to; or
>: if there is no pending SR already triggered by the DSR procedure for any logical channel with higher LCP than the first LCH:
>>: trigger a Scheduling Request.
if there is a pending SR already triggered by the DSR procedure for a LCH of the LCG with higher LCP than the first LCH, UE does not trigger a SR. first LCH is LCH with the pending DSR.

An SDU is considered to be associated with a DSR if it has not been transmitted in any MAC PDU and it is associated with the LCH which triggered the DSR and the remaining value of its PDCP discardTimer is below remaining Time Threshold.

A MAC PDU shall contain at most one (extended) DSR MAC CE.

The MAC entity shall not include a DSR MAC CE in a MAC PDU if the MAC PDU can accommodate the SDUs associated with all the pending DSRs.

After a DSR is triggered, it is considered as pending until it is cancelled. The MAC entity shall cancel a pending DSR, either when all the SDUs associated with the DSR have been discarded, or when a MAC PDU is transmitted and this MAC PDU includes a DSR MAC CE that contains the delay information of all the SDUs associated with the DSR. The MAC entity may cancel a pending DSR when a MAC PDU is transmitted and this MAC PDU includes all the SDUs associated with the DSR but is not sufficient to include the DSR MAC CE and its subheader.

The first additional delay status for an LCG includes:
>: remaining time of which is:
>>: second smallest remaining value of the running PDCP discardTimers among SUDs that are buffered for the LCG but have not been transmitted in any MAC PDU; and
>>: greater than remainingTime Threshold and smaller than remaingingTimeThresholdRep.
>: Total amount of specific UL data for the LCG, the specific UL data for the LCG comprises PDCP SDUs:
>>: of which remaining value of the running PDCP discardTimer is greater than remainingTimeThreshold and smaller than remaining Time ThresholdRep;
>>: of which data volume is not reported in other additional delay status (or in the extended DSR);

The second additional delay status for an LCG includes:
>: remaining time of which is:
>>: third smallest remaining value for the running PDCP discardTimers among SDUs that are buffered for the LCG but have not been transmitted in any MAC PDU; and
>>: greater than remainingTimeThreshold and smaller than remaingingTimeThresholdRep.
>: Total amount of specific UL data for the LCG, the specific UL data for the LCG comprises PDCP SDUs:
>>: of which remaining value of the running PDCP discardTimer is greater than remainingTimeThreshold and smaller than remaining Time ThresholdRep;
>>: of which data volume is not reported in other additional delay status (or in the extended DSR);
and so on until there is no more UL data of which remaining time is smaller than remainingTimeThreshold.

Alternatively (since PDU SUDs within a PDCP set have different remaining times but are discarded same time), if pdu-SetDiscard is configured, followings may apply.

The first additional delay status for an LCG includes:
>: remaining time of the LCG that is:
>>: second smallest remaining value for the running PDCP discardTimers assicated with PDU Sets that are buffered for the LCG but at least one SDU of the PDU Set has not been transmitted in any MAC PDU; and
>>: greater than remaining TimeThreshold and smaller than remaingingTimeThresholdRep.
>: Total amount of specific UL data for the LCG, the specific UL data for the LCG comprises PDCP SDUs:
>>: that belongs to the PDU Set of which remaining value is indicated in the remaining time (data volume of PDCP SDUs that have not been transmitted and belong to the PDU Set);

The second additional delay status for an LCG includes:
>: remaining time of the LCG that is:
>>: third smallest remaining value for the running PDCP discardTimers among PUD sets that are buffered for the LCG but at least one SDU of the PDU Set has not been transmitted in any MAC PDU; and
>>: greater than remainingTimeThreshold and smaller than remaingingTimeThresholdRep.
>: Total amount of specific UL data for the LCG, the specific UL data for the LCG comprises PDCP SDUs:
>>: that belongs to the PDU Set of which remaining value is indicated in the remaining time (data volume of PDCP SDUs that have not been transmitted and belong to the PDU Set);
and so on until there is no more PDU Set of which remaining value of running PDCP discardTimer is smaller than remainingTime Threshold.

### Extended Delay Status Reporting

The Extended DSR provides the serving GNB with baseline delay status and zero or more additional delay status of LCGs. This baseline delay status for an LCG includes remaining time, which is the smallest remaining value of the running PDCP discardTimers among SDUs that are buffered for the LCG but have not been transmitted in any MAC PDU and the total amount of delay-critical UL data for the LCG according to the data volume calculation procedure for the associated RLC and PDCP entities, respectively.

RRC controls the DSR procedure by configuring the following parameter:
>: remainingTimeThreshold (per LCG): the threshold on remaining time for triggering an extended DSR for a LCH of the corresponding LCG.
>: remingaingTimeThresholdRep (per LCG): the threshold on remaining time for data volume reporting in the triggered extended DSR

If an LCG is configured for extended delay status reporting (e.g. a LCG is configured for extended delay status reporting in case that the LCG is listed in the dsr-ConfigToAddModListExt and that extendedDSRenabled is configured), the MAC entity shall for each LCH of the LCG:
>: if the smallest remaining value of the running PDCP discardTimers among all the SDUs buffered for the LCH that have not been transmitted in any MAC PDU and have not been reported as (delay-critical) data volume (in baseline delay information part) in an extended DSR MAC CE becomes below remainingTimeThreshold of the LCG; and
>: if there is no extended DSR pending for any LCH of the LCG (or if there is no extended DSR pending for a LCH of the LCG that are configured with the higher LCP than the LCH):
>>: trigger an extended DSR for the LCH.

If there is at least one extended DSR pending for a LCH, the MAC entity shall:
>: if UL-SCH resources are available for a new transmission and the UL-SCH resources can accommodate the extended DSR MAC CE plus its subheader as a result of logical channel prioritization:
>>: instruct the Multiplexing and Assembly procedure to generate the extended DSR MAC CE.
>: else if there is no pending SR already triggered by the extended DSR procedure for any logical channel with higher LCP than the LCH for which extended DSR is pending:
>>: trigger a Scheduling Request.

An SDU is considered to be associated with an extended DSR if it has not been transmitted in any MAC PDU and it is associated with the LCH which triggered the extended DSR and the remaining value of its PDCP discardTimer is below remaining TimeThresholdRep.

A MAC PDU shall contain at most one extended DSR MAC CE. A MAC PDU shall not contain a DSR MAC CE and an extended DSR MAC CE at the same time.

The MAC entity shall not include an extended DSR MAC CE in a MAC PDU if the MAC PDU can accommodate the SDUs associated with all the pending extended DSRs.

After an extended DSR is triggered, it is considered as pending until it is cancelled. The MAC entity shall cancel a pending extended DSR, either when all the SDUs associated with the extended DSR have been discarded, or when a MAC PDU is transmitted and this MAC PDU includes an extended DSR MAC CE that contains the delay information of all the SDUs associated with the extended DSR. The MAC entity may cancel a pending extended DSR when a MAC PDU is to be transmitted and this MAC PDU includes all the SDUs associated with the extended DSR but is not sufficient to include the extended DSR MAC CE and its subheader.

### Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery and for consistent LBT failure recovery, at most one PUCCH resource for SR is configured per BWP. For a logical channel serving a radio bearer configured with SDT, PUCCH resource for SR is not configured for SDT. For beam failure recovery of BFD-RS set(s) of Serving Cell, up to two PUCCH resources for SR is configured per BWP. For positioning measurement gap activation/deactivation request, a dedicated SR configuration is configured.

Each SR configuration corresponds to one or more logical channels and/or to SCell beam failure recovery and/or to consistent LBT failure recovery and/or to beam failure recovery of a BFD-RS set and/or to positioning measurement gap activation/deactivation request. Each logical channel, SCell beam failure recovery, beam failure recovery of a BFD-RS set and consistent LBT failure recovery, may be mapped to zero or one SR configuration, which is configured by RRC. The SR configuration of the logical channel that triggered a BSR or a DSR or an extended DSR or the SCell beam failure recovery or the beam failure recovery of a BFD-RS set or the consistent LBT failure recovery (if such a configuration exists) or positioning measurement gap activation/deactivation request is considered as corresponding SR configuration for the triggered SR. Any SR configuration may be used for an SR triggered by Pre-emptive BSR or Timing Advance reporting.

RRC configures the following parameters for the scheduling request procedure:
>: sr-ProhibitTimer (per SR configuration);
>: sr-TransMax (per SR configuration).

The following UE variables are used for the scheduling request procedure:
>: SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

All pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long, Refined Long or Short BSR MAC CE which contains buffer status up to (and including) the last event that triggered a BSR (see clause 5.4.5) prior to the MAC PDU assembly. All pending SR(s) for BSR triggered according to the BSR procedure (clause 5.4.5) shall be cancelled and each respective sr-ProhibitTimer shall be stopped when the UL grant(s) can accommodate all pending data available for transmission.

The MAC entity shall for each pending SR not triggered according to the BSR procedure for a Serving Cell:
>: if this SR was triggered by Pre-emptive BSR procedure (see clause 5.4.7) prior to the MAC PDU assembly and a MAC PDU containing the relevant Pre-emptive BSR MAC CE is transmitted; or
>: if this SR was triggered by beam failure recovery of an SCell and a MAC PDU is transmitted and this PDU includes a MAC CE for BFR which contains beam failure recovery information for this SCell; or
>: if this SR was triggered by beam failure recovery for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or
>: if this SR was triggered by beam failure recovery of an SCell and this SCell is deactivated; or
>: if this SR was triggered by beam failure recovery for a BFD-RS set of an SCell and this SCell is deactivated; or
>: if the SR is triggered by positioning measurement gap activation/deactivation request and the Positioning Measurement Gap Activation/Deactivation Request MAC CE that triggers the SR has already been cancelled; or
>: if this SR was triggered by consistent LBT failure recovery of an SCell and a MAC PDU is transmitted and the MAC PDU includes an LBT failure MAC CE that indicates consistent LBT failure for this SCell; or
>: if this SR was triggered by consistent LBT failure recovery of an SCell and all the triggered consistent LBT failure(s) for this SCell are cancelled; or
>: if this SR was triggered by Timing Advance reporting and all the triggered Timing Advance reports are cancelled; or
>: if this SR was triggered by DSR procedure and the DSR that triggered the SR has been cancelled; or
>: if this SR was triggered by extended DSR procedure and the extended DSR that triggered the SR has been cancelled:
>>: cancel the pending SR and stop the corresponding sr-ProhibitTimer, if running.

Only PUCCH resources on a BWP which is active at the time of SR transmission occasion are considered valid.

As long as at least one SR is pending, the MAC entity shall for each pending SR:
>: if the MAC entity has no valid PUCCH resource configured for the pending SR; and
>: if there is no ongoing LTM cell switch; and
>: if rach-lessHO is not configured:
>>: initiate a Random Access procedure on the SpCell and cancel the pending SR.
>: else, for the SR configuration corresponding to the pending SR:
>>: when the MAC entity has an SR transmission occasion on the valid PUCCH resource for SR configured; and
>>: if sr-ProhibitTimer is not running at the time of the SR transmission occasion; and
>>: if the PUCCH resource for the SR transmission occasion does not overlap with a measurement gap:
>>>: if SR_COUNTER<sr-TransMax:
>>>>: instruct the physical layer to signal the SR on one valid PUCCH resource for SR;
>>>>: if LBT failure indication is not received from lower layers:
>>>>>: increment SR_COUNTER by 1;
>>>>>: start the sr-ProhibitTimer.
>>>>: else if lbt-FailureRecoveryConfig is not configured:
>>>>>: increment SR_COUNTER by 1.
>>>: else:
>>>>: notify RRC to release PUCCH for all Serving Cells;
>>>>: notify RRC to release SRS for all Serving Cells;
>>>>: clear any configured downlink assignments and uplink grants;
>>>>: clear any PUSCH resources for semi-persistent CSI reporting;
>>>>: if rach-lessHO is not configured and if there is no ongoing LTM cell switch:
>>>>>: initiate a Random Access procedure on the SpCell and cancel all pending SRs.

The MAC entity may stop, if any, ongoing Random Access procedure due to a pending SR for BSR, which was initiated by the MAC entity prior to the MAC PDU assembly and which has no valid PUCCH resources configured, if:
>: a MAC PDU is transmitted using a UL grant other than a UL grant provided by Random Access Response or a UL grant determined for the transmission of the MSGA payload, and this PDU includes a BSR MAC CE which contains buffer status up to (and including) the last event that triggered a BSR prior to the MAC PDU assembly; or
>: the UL grant(s) can accommodate all pending data available for transmission.

The MAC entity may stop, if any, ongoing Random Access procedure due to a pending SR for BFR of an SCell, which has no valid PUCCH resources configured, if:
>: a MAC PDU is transmitted using a UL grant other than a UL grant provided by Random Access Response or a UL grant determined for the transmission of the MSGA payload, and this PDU contains a MAC CE for BFR which includes beam failure recovery information of that SCell; or
>: the SCell is deactivated and all triggered BFRs for SCells are cancelled.

The MAC entity may stop, if any, ongoing Random Access procedure due to a pending SR for BFR of a BFD-RS set of a Serving Cell, which has no valid PUCCH resources configured, if:
>: a MAC PDU is transmitted using a UL grant other than a UL grant provided by Random Access Response or a UL grant determined for the transmission of the MSGA payload, and this PDU contains an Enhanced BFR MAC CE or a Truncated Enhanced BFR MAC CE which includes beam failure recovery information of that BFD-RS set of the Serving Cell.

The MAC entity may stop, if any, ongoing Random Access procedure due to a pending SR for DSR, which has no valid PUCCH resources configured, if:
>: a MAC PDU is transmitted using a UL grant other than a UL grant provided by Random Access Response or a UL grant for the transmission of the MSGA payload, and this PDU includes either a DSR MAC CE or all the PDCP SDUs associated with the DSR; or
>: all the PDCP SDUs associated with the DSR have been discarded.

The MAC entity may stop, if any, ongoing Random Access procedure due to a pending SR for extended DSR, which has no valid PUCCH resources configured, if:
>: a MAC PDU is transmitted using a UL grant other than a UL grant provided by Random Access Response or a UL grant for the transmission of the MSGA payload, and this PDU includes either an extended DSR MAC CE or all the PDCP SDUs associated with the extended DSR; or
>: all the PDCP SDUs associated with the extended DSR have been discarded.

The MAC entity may stop, if any, ongoing Random Access procedure due to a pending SR for SL-PRS Resource Request, which has no valid PUCCH resources configured, if:
>: a MAC PDU is transmitted using a UL grant other than a UL grant provided by Random Access Response or a UL grant determined for the transmission of the MSGA payload, and this PDU includes a SL-PRS Resource Request MAC CE.

### Data Volume Calculation

For the purpose of MAC delay status reporting, the transmitting PDCP entity shall consider the following as delay-critical PDCP data volume:
>: the delay-critical PDCP SDUs for which no PDCP Data PDUs have been constructed;
>: the PDCP Data PDUs that contain the delay-critical PDCP SDUs and have not been submitted to lower layers;
>: the PDCP Control PDUs;
>: for AM DRBs, the PDCP SDUs to be retransmitted;
>: for AM DRBs, the PDCP Data PDUs to be retransmitted.

For the purpose of MAC delay status reporting, the transmitting PDCP entity shall consider the following as reported-non-delay-critical PDCP data volume:
>: one or more PDCP SDUs that belong to a reported-non-delay-critical PDU Set and for which no PDCP Data PDUs have been constructed;
>: the PDCP Data PDUs that contain the PDCP SDUs belong to a reported-non-delay-critical PDU Set and have not been submitted to lower layers.

If a PDCP SDU becomes a delay-critical PDCP SDU, and if the corresponding PDCP Data PDU has already been submitted to lower layers, the delay-critical indication for the PDCP Data PDU is provided to lower layers.

If the transmitting PDCP entity is associated with at least two RLC entities, when indicating the delay-critical PDCP data volume to a MAC entity for DSR triggering and Buffer Size calculation, the transmitting PDCP entity shall:
>: if the PDCP duplication is activated for the RB:
>: indicate the delay-critical PDCP data volume to the MAC entity associated with the primary RLC entity;
>: indicate the delay-critical PDCP data volume excluding the PDCP Control PDU to the MAC entity associated with the RLC entity other than the primary RLC entity activated for PDCP duplication;
>: indicate the delay-critical PDCP data volume as 0 to the MAC entity associated with RLC entity deactivated for PDCP duplication;
>: else (i.e. the PDCP duplication is deactivated for the RB):
>: if the split secondary RLC entity is configured; and
>: if the total amount of PDCP data volume and RLC data volume pending for initial transmission in the primary RLC entity and the split secondary RLC entity is equal to or larger than ul-DataSplitThreshold:
>: indicate the delay-critical PDCP data volume to both the MAC entity associated with the primary RLC entity and the MAC entity associated with the split secondary RLC entity;
>: indicate the delay-critical PDCP data volume as 0 to the MAC entity associated with RLC entity other than the primary RLC entity and the split secondary RLC entity;
>: else:
>: indicate the delay-critical PDCP data volume to the MAC entity associated with the primary RLC entity;
>: indicate the delay-critical PDCP data volume as 0 to the MAC entity associated with the RLC entity other than the primary RLC entity.

Delay-critical PDCP SDU: if pdu-SetDiscard is not configured, a PDCP SDU for which the remaining time till discardTimer expiry is less than the remainingTimeThreshold. If pdu-SetDiscard is configured, a PDCP SDU belonging to a PDU Set of which at least one PDCP SDU has the remaining time till discardTimer expiry less than the remaining Time Threshold.

Delay-critical PDU Set: a PDU Set of which at least one PDCP SDU has the remaining time till discardTimer expiry less than the remainingTimeThreshold.

Reported non-delay-critical PDU Set: a PDU Set of which at least one PDCP SDU has the remaining time until discardTimer expiry more than the remianingTimeThreshold and less than the remainingTimeThresholdRep.

Delay-critical RLC SDU: RLC SDU corresponding to a PDCP PDU indicated as delay-critical by PDCP.

For the purpose of MAC buffer status reporting, the UE shall consider the following as RLC data volume:
>: RLC SDUs and RLC SDU segments that have not yet been included in an RLC data PDU;
>: RLC data PDUs that are pending for initial transmission;
>: RLC data PDUs that are pending for retransmission (RLC AM).

For the purpose of MAC delay status reporting, the UE shall consider the following as delay-critical RLC data volume:
>: delay-critical RLC SDUs and delay-critical RLC SDU segments that have not yet been included in an RLC data PDU;
>: RLC data PDUs pending for initial transmission, and containing a delay-critical RLC SDU or a delay-critical RLC SDU segment;
>: RLC data PDUs that are pending for retransmission (RLC AM).

In addition, if a STATUS PDU has been triggered and t-StatusProhibit is not running or has expired, the UE shall estimate the size of the STATUS PDU that will be transmitted in the next transmission opportunity, and consider this as part of RLC data volume for MAC buffer status reporting and as part of delay-critical RLC data volume for MAC delay status reporting.

The RRCReconfiguration message is the command to modify an RRC connection. It may convey information for measurement configuration, mobility control, radio resource configuration (including RBs, MAC main configuration and physical channel configuration) and AS security configuration.

```
  -- ASN1START
  -- TAG-RRCRECONFIGURATION-START
```

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

```
    }
  }
```

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING |
| (CONTAINING CellGroupConfig) | OPTIONAL, -- Cond |

SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

```
OPTIONAL
  }
  -- TAG-RRCRECONFIGURATION-STOP
  -- ASN1STOP
```

The RRCRelease message is used to command the release of an RRC connection or the suspension of the RRC connection.

```
  Signalling radio bearer: SRB1
  RLC-SAP: AM
  Logical channel: DCCH
  Direction: Network to UE
  RRCRelease message
  -- ASN1START
  -- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

```
    }
  }
```

| | |
|---|---|
| RRCRelease-IEs ::= | SEQUENCE { |
| redirectedCarrierInfo | RedirectedCarrierInfo |

OPTIONAL, -- Need N

| | |
|---|---|
| cellReselectionPriorities | CellReselectionPriorities |

OPTIONAL, -- Need R

| | |
|---|---|
| suspendConfig | SuspendConfig |

OPTIONAL, -- Need R

| | |
|---|---|
| deprioritisationReq | SEQUENCE { |
| deprioritisationType | ENUMERATED {frequency, nr}, |
| deprioritisationTimer | ENUMERATED {min5, min10, |

min15, min30}
}
OPTIONAL, -- Need N

| | |
|---|---|
| lateNonCriticalExtension | OCTET STRING |

OPTIONAL,

| | |
|---|---|
| nonCriticalExtension | RRCRelease-v1540-IEs |

OPTIONAL
}

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |
| ran-NotificationAreaInfo | RAN-NotificationAreaInfo |

OPTIONAL, -- Need M

| | |
|---|---|
| t380 | PeriodicRNAU-TimerValue |

OPTIONAL, -- Need R

| | |
|---|---|
| nextHopChainingCount | NextHopChainingCount, |

```
    ...,
  }
  -- TAG-RRCRELEASE-STOP
  -- ASN1STOP
```

suspendConfig: Indicates configuration for the RRC_INACTIVE state. The network does not configure suspendConfig when the network redirect the UE to an inter-RAT carrier frequency or if the UE is configured with a DAPS bearer.

ncd-SSB-RedCapInitialBWP-SDT: Indicates that the UE uses the RedCap-specific initial DL BWP associated with the NCD-SSB for SDT. The network configures this field if an (e) RedCap UE is configured with SDT in the RedCap-specific initial DL BWP not associated with CD-SSB. If configured, the NCD-SSB indicated by this field can only be used during the SDT procedure for CG-SDT or RA-SDT. In the MIB associated with this NCD-SSB, the systemFrameNumber field indicates the frame boundary and frame number of the NCD-SSB. The subCarrierSpacingCommon and dmrs-TypeA-Position field in the MIBs associated with CD-SSB and NCD-SSB in the same cell are configured with the same values, respectively.

ran-ExtendedPagingCycle: The extended DRX (eDRX) cycle for RAN-initiated paging to be applied by the UE. Value rf256 corresponds to 256 radio frames, value rf512 corresponds to 512 radio frames and so on. Value of the field indicates an eDRX cycle which is shorter or equal to the IDLE mode eDRX cycle configured for the UE.

ran-NotificationAreaInfo: Network ensures that the UE in RRC_INACTIVE always has a valid ran-NotificationAreaInfo.

ran-PagingCycle: Refers to the UE specific cycle for RAN-initiated paging. Value rf32 corresponds to 32 radio frames, value rf64 corresponds to 64 radio frames and so on.

resumeIndication: Indicates that the UE shall trigger the RRC connection resume procedure after receiving this RRCRelease message. The network only includes this field in the RRCRelease message used to terminate an ongoing SDT procedure.

sl-UEIdentityRemote: Indicates the C-RNTI to the L2 U2N Remote UE.

t380: Refers to the timer that triggers the periodic RNAU procedure in UE. Value min5 corresponds to 5 minutes, value min 10 corresponds to 10 minutes and so on.

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells). For an NCR-MT, the CellGroupConfig IE is also used to provide the configuration of side control information for the NCR-Fwd access link.

```
  -- ASN1START
  -- TAG-CELLGROUPCONFIG-START
  -- Configuration of one Cell-Group:
```

| | |
|---|---|
| CellGroupConfig ::= | SEQUENCE { |
| cellGroupId | CellGroupId, |
| rlc-BearerToAddModList | SEQUENCE |
| (SIZE(1..maxLC-ID)) OF RLC-BearerConfig | OPTIONAL, - |

- Need N

| | |
|---|---|
| rlc-BearerToReleaseList | SEQUENCE |
| (SIZE(1..maxLC-ID)) OF LogicalChannelIdentity | OPTIONAL, -- |

Need N

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE |
| (1..maxNrofSCells)) OF SCellConfig | OPTIONAL, -- Need N |
| sCellToReleaseList | SEQUENCE (SIZE |
| (1..maxNrofSCells)) OF SCellIndex | OPTIONAL, -- Need N |

```
    ...,
  -- TAG-CELLGROUPCONFIG-STOP
  -- ASN1STOP
  mac-CellGroupConfig: MAC parameters applicable for the entire cell group.
  rlc-BearerToAddModList: Configuration of the MAC Logical Channel, the
corresponding RLC entities and association with radio bearers.
  The IE MAC-CellGroupConfig is used to configure MAC parameters for a cell group,
including DRX.
  -- ASN1START
  -- TAG-MAC-CELLGROUPCONFIG-START
```

| | |
|---|---|
| MAC-CellGroupConfig ::= | SEQUENCE { |

| | |
|---|---|
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| | |
|---|---|
| skipUplinkTxDynamic | BOOLEAN, |

```
    ...,
    [[
```

| | |
|---|---|
| csi-Mask | BOOLEAN |

OPTIONAL, -- Need M

| | |
|---|---|
| dataInactivityTimer | SetupRelease { DataInactivityTimer } |

```
OPTIONAL -- Cond MCG-Only
    ]],
    [[
```

| | |
|---|---|
| usePreBSR-r16 | ENUMERATED {true} |

OPTIONAL, -- Need R

| | |
|---|---|
| schedulingRequestID-LBT-SCell-r16 | SchedulingRequestId |

OPTIONAL, -- Need R

| | |
|---|---|
| lch-BasedPrioritization-r16 | ENUMERATED {enabled} |

OPTIONAL, -- Need R

| | |
|---|---|
| schedulingRequestID-BFR-SCell-r16 | SchedulingRequestId |

OPTIONAL, -- Need R

| | |
|---|---|
| drx-ConfigSecondaryGroup-r16 | SetupRelease { DRX- |

| | |
|---|---|
| ConfigSecondaryGroup-r16 } | OPTIONAL -- Need M |

]],

| | |
|---|---|
| additionalBS-TableAllowed-r18 | BIT STRING (SIZE (maxNrofLCGs- |

| | |
|---|---|
| r18)) | OPTIONAL, -- Need R |

| | |
|---|---|
| dsr-ConfigToAddModList-r18 | SEQUENCE (SIZE |
| (1..maxNrofLCGs-r18)) OF LCG-DSR-Config-r18 | OPTIONAL, -- Need |

N

| | |
|---|---|
| dsr-ConfigToReleaseList-r18 | SEQUENCE (SIZE (1..maxNrofLCGs- |
| r18)) OF LCG-Id-r18 | OPTIONAL, -- Need N |

| | |
|---|---|
| tar-Config-r18 | SetupRelease { TAR-Config-r18 } |

```
OPTIONAL -- Need M
    ]]
  [[
```

| | |
|---|---|
| dsr-ReportConfigToAddModList-r18 | SEQUENCE (SIZE |

```
(1..maxNrofLCGs-r18)) OF LCG-DSR-ReportConfig OPTIONAL, -- Need N
  ]]
  }
```

| | |
|---|---|
| DataInactivityTimer ::= | ENUMERATED {s1, s2, s3, s5, s7, s10, s15, s20, |

s40, s50, s60, s80, s100, s120, s150, s180}
LCG-DSR-Config-r18 ::= SEQUENCE {

| | |
|---|---|
| lcg-Id-r18 | LCG-Id-r18, |
| remainingTimeThreshold-r18 | INTEGER (1..64), |

| | |
|---|---|
| extendedDSRenabled | ENUMERATED {true} |

```
OPTIONAL, -- Need R
    ...
  }
  LCG-DSR-ReportConfig-r18 ::= SEQUENCE {
```

| | |
|---|---|
| lcg-Id-r18 | LCG-Id-r18, |

| | |
|---|---|
| remainingTimeThresholdRep | INTEGER (1..64), |

```
    ...
  }
  LCG-Id-r18 ::= INTEGER (0..maxLCG-ID)
  -- TAG-MAC-CELLGROUPCONFIG-STOP
  -- ASN1STOP
```

additionalBS-TableAllowed: Indicates whether a UE is allowed to utilize the refined buffer size levels, for a certain Logical Channel Group. The leftmost bit corresponds to LCG ID=0, second leftmost bit to LCG ID=1 and so on. The UE is allowed to utilize the refined buffer size levels for a Logical Channel Group only when the corresponding bit is set to 1.

dataInactivityTimer: Releases the RRC connection upon data inactivity. Value s1 corresponds to 1 second, value s2 corresponds to 2 seconds, and so on.

drx-Config, drx-ConfigExt, drx-ConfigExt2: Used to configure DRX. Network only configures drx-ConfigExt or drx-ConfigExt2 when drx-Config is configured.

drx-ConfigSecondaryGroup: Used to configure DRX related parameters for the second DRX group. The network does not configure secondary DRX group with DCP simultaneously nor secondary DRX group with a dormant BWP simultaneously.

dsr-ConfigToAddModList: List of LCG-specific DSR configurations to add or modify.

dsr-ConfigToReleaseList: List of LCG-specific DSR configurations to release.

posMG-Request: Indicates whether UE is configured to send UL MAC CE for Positioning Measurement Gap Activation/Deactivation Request.

lcg-Id: Identifier of the Logical Channel Group which the DSR configuration refers to.

remainingTimeThreshold: Remaining time threshold used for triggering DSR for the Logical Channel Group. Value in number of miliseconds.

remainingTimeThresholdRep: Remaining time threshold used by UE to decide whether to report delay status for the Logical Channel Group,

The IE RadioBearerConfig is used to add, modify and release signalling, multicast MRBs and/or data radio bearers. Specifically, this IE carries the parameters for PDCP and, if applicable, SDAP entities for the radio bearers.

```
  -- ASN1START
  -- TAG-RADIOBEARERCONFIG-START
```

| | |
|---|---|
| RadioBearerConfig ::= | SEQUENCE { |
| srb-ToAddModList | SRB-ToAddModList |

OPTIONAL, -- Cond HO-Conn

| | |
|---|---|
| srb3-ToRelease | ENUMERATED{true} |

OPTIONAL, -- Need N

| | |
|---|---|
| drb-ToAddModList | DRB-ToAddModList |

OPTIONAL, -- Cond HO-toNR

| | |
|---|---|
| drb-ToReleaseList | DRB-ToReleaseList |

OPTIONAL, -- Need N

| | |
|---|---|
| securityConfig | SecurityConfig |

```
OPTIONAL, -- Need M
    ...,
    [[
```

| | |
|---|---|
| mrb-ToAddModList-r17 | MRB-ToAddModList-r17 |

OPTIONAL, -- Need N

| | |
|---|---|
| mrb-ToReleaseList-r17 | MRB-ToReleaseList-r17 |

OPTIONAL, -- Need N

| | |
|---|---|
| srb4-ToAddMod-r17 | SRB-ToAddMod |

OPTIONAL, -- Need N

| | |
|---|---|
| srb4-ToRelease-r17 | ENUMERATED{true} |

```
OPTIONAL -- Need N
    ]],
    [[
```

| | |
|---|---|
| srb5-ToAddMod-r18 | SRB-ToAddMod |

OPTIONAL, -- Need N

| | |
|---|---|
| srb5-ToRelease-r18 | ENUMERATED{true} |

```
OPTIONAL -- Need N
    ]]
  }
```

| | |
|---|---|
| SRB-ToAddModList ::= | SEQUENCE (SIZE (1..2)) OF SRB- |

ToAddMod

| | |
|---|---|
| SRB-ToAddMod ::= | SEQUENCE { |
| srb-Identity | SRB-Identity, |
| reestablishPDCP | ENUMERATED{true} |

OPTIONAL, -- Need N

| | |
|---|---|
| discardOnPDCP | ENUMERATED{true} |

OPTIONAL, -- Need N

| | |
|---|---|
| pdcp-Config | PDCP-Config |

```
OPTIONAL, -- Cond PDCP
    ...,
    [[
```

| | |
|---|---|
| srb-Identity-v1700 | SRB-Identity-v1700 |

```
OPTIONAL -- Need M
    ]],
    [[
```

| | |
|---|---|
| srb-Identity-v1800 | SRB-Identity-v1800 |

OPTIONAL, -- Need M

| | |
|---|---|
| n3c-BearerAssociated-r18 | ENUMERATED{true} |

```
OPTIONAL -- Cond N3C MP
    ]]
  }
```

| | |
|---|---|
| DRB-ToAddModList ::= | SEQUENCE (SIZE (1..maxDRB)) |

OF DRB-ToAddMod

| | |
|---|---|
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| | |
|---|---|
| drb-Identity | DRB-Identity, |
| reestablishPDCP | ENUMERATED{true} |

OPTIONAL, -- Need N

| | |
|---|---|
| recoverPDCP | ENUMERATED{true} |

OPTIONAL, -- Need N

| | |
|---|---|
| pdcp-Config | PDCP-Config |

```
OPTIONAL, -- Cond PDCP
    ...,
    [[
```

| | |
|---|---|
| daps-Config-r16 | ENUMERATED{true} |

```
OPTIONAL -- Cond DAPS
    ]],
    [[
```

| | |
|---|---|
| n3c-BearerAssociated-r18 | ENUMERATED{true} |

```
OPTIONAL -- Cond N3C MP
    ]]
  }
```

| | |
|---|---|
| DRB-ToReleaseList ::= | SEQUENCE (SIZE (1..maxDRB)) OF |

DRB-Identity

| | |
|---|---|
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, |
| secondary} | OPTIONAL, -- Cond RBTermChange |

```
    ...
  }
```

| | |
|---|---|
| MRB-ToAddModList-r17 ::= | SEQUENCE (SIZE (1..maxMRB- |

r17)) OF MRB-ToAddMod-r17

| | |
|---|---|
| MRB-ToAddMod-r17 ::= | SEQUENCE { |
| mbs-SessionId-r17 | TMGI-r17 |

OPTIONAL, -- Cond MRBSetup

| | |
|---|---|
| mrb-Identity-r17 | MRB-Identity-r17, |
| mrb-IdentityNew-r17 | MRB-Identity-r17 |

OPTIONAL, -- Need N

| | |
|---|---|
| reestablishPDCP-r17 | ENUMERATED{true} |

OPTIONAL, -- Need N

| | |
|---|---|
| recoverPDCP-r17 | ENUMERATED{true} |

OPTIONAL, -- Need N

| | |
|---|---|
| pdcp-Config-r17 | PDCP-Config |

```
OPTIONAL, -- Cond PDCP
    ...
  }
```

| | |
|---|---|
| MRB-ToReleaseList-r17 ::= | SEQUENCE (SIZE (1..maxMRB- |

```
r17)) OF MRB-Identity-r17
  -- TAG-RADIOBEARERCONFIG-STOP
  -- ASN1STOP
```

cnAssociation: Indicates if the bearer is associated with the eps-bearerIdentity (when connected to EPC) or sdap-Config (when connected to 5GC).

daps-Config: Indicates that the bearer is configured as DAPS bearer.

drb-Identity: In case of DC, the DRB identity is unique within the scope of the UE, i.e. an MCG DRB cannot use the same value as a split DRB. For a split DRB the same identity is used for the MCG and SCG parts/indirect path of the configuration.

eps-BearerIdentity: The EPS bearer ID determines the EPS bearer.

reestablishPDCP: Indicates that PDCP should be re-established. Network sets this to true whenever the security key used for this radio bearer changes. Key change could for example be due to termination point change for the bearer, reconfiguration with sync, resuming an RRC connection, or the first reconfiguration after reestablishment. It is also applicable for LTE procedures when NR PDCP is configured. Network doesn't include this field for DRB if the bearer is configured as DAPS bearer or if the RadioBearerConfig IE is part of an RRCReconfiguration message within the LTM-Config IE. or if the RadioBearerConfig IE is part of an RRCReconfiguration message associated with subsequent CPAC within the ConditionalReconfiguration IE.

recoverPDCP: Indicates that PDCP should perform recovery according to TS 38.323 [5]. Network doesn't include this field if the bearer is configured as DAPS bearer or if the RadioBearerConfig IE is part of an RRCReconfiguration message within the LTM-Config IE or if the RadioBearerConfig IE is part of an RRCReconfiguration message associated with subsequent CPAC within the ConditionalReconfiguration IE.

sdap-Config: The SDAP configuration determines how to map QoS flows to DRBs when NR or E-UTRA connects to the 5GC and presence/absence of UL/DL SDAP headers.

securityConfig: Indicates the security algorithm and key to use for the signalling and data radio bearers configured with the list in this IE RadioBearerConfig. When the field is not included after AS security has been activated, the UE shall continue to use the currently configured keyToUse and security algorithm for the radio bearers reconfigured with the lists in this IE RadioBearerConfig. The field is not included when configuring SRBI before AS security is activated.

srb3-ToRelease: Release SRB3. SRB3 release can only be done over SRBI and only at SCG release and reconfiguration with sync.

keyToUse: Indicates if the bearers configured with the list in this IE RadioBearerConfig are using the master key or the secondary key for deriving ciphering and/or integrity protection keys. For MR-DC, network should not configure SRB1 and SRB2 with secondary key and SRB3 with the master key. When the field is not included, the UE shall continue to use the currently configured keyToUse for the radio bearers reconfigured with the lists in this IE RadioBearerConfig.

security AlgorithmConfig: Indicates the security algorithm for the signalling and data radio bearers configured with the list in this IE RadioBearerConfig. When the field is not included, the UE shall continue to use the currently configured security algorithm for the radio bearers reconfigured with the lists in this IE RadioBearerConfig.

discardOnPDCP: Indicates that PDCP should discard stored SDU and PDU according to TS 38.323 [5]. For SRB3, network doesn't include this field if the RadioBearerConfig IE is part of an RRCReconfiguration message associated with subsequent CPAC within the ConditionalReconfiguration IE.

reestablishPDCP: Indicates that PDCP should be re-established. Network sets this to true whenever the security key used for this radio bearer changes. Key change could for example be due to reconfiguration with sync, for SRB2 when resuming an RRC connection, or at the first reconfiguration after RRC connection reestablishment in NR. For SRB1, when resuming an RRC connection, or at the first reconfiguration after RRC connection reestablishment in NR, the network does not set this field to true. For LTE SRBs using NR PDCP, it could be for handover, RRC connection reestablishment or resume. Network doesn't include this field if any DAPS bearer is configured or if the RadioBearerConfig IE is part of an RRCReconfiguration message within the LTM-Config IE. For SRB3, network doesn't include this field if the RadioBearerConfig IE is part of an RRCReconfiguration message associated with subsequent CPAC within the ConditionalReconfiguration IE.

srb-Identity, srb-Identity-v1700, srb-Identity-v1800: Value 1 is applicable for SRB1 only. Value 2 is applicable for SRB2 only. Value 3 is applicable for SRB3 only. Value 4 is applicable for SRB4 only. Value 5 is applicable for SRB5 only. If srb-Identity-v1700 or srb-Identity-v1800 is received for an SRB, the UE shall ignore srb-Identity (i.e. without suffix) for this SRB.

The IE RLC-BearerConfig is used to configure an RLC entity, a corresponding logical channel in MAC and the linking to a PDCP entity (served radio bearer).

```
  -- ASN1START
  -- TAG-RLC-BEARERCONFIG-START
```

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

}
OPTIONAL, -- Cond LCH-SetupOnly

| | |
|---|---|
| reestablishRLC | ENUMERATED {true} |

OPTIONAL, -- Need N

| | |
|---|---|
| rlc-Config | RLC-Config |

OPTIONAL, -- Cond LCH-Setup

| | |
|---|---|
| mac-LogicalChannelConfig | LogicalChannelConfig |

```
OPTIONAL, -- Cond LCH-Setup
    ...,
    [[
```

| | |
|---|---|
| rlc-Config-v1610 | RLC-Config-v1610 |

```
OPTIONAL -- Need R
    ]],
    [[
```

| | |
|---|---|
| rlc-Config-v1700 | RLC-Config-v1700 |

OPTIONAL, -- Need R

| | |
|---|---|
| logicalChannelIdentityExt-r17 | LogicalChannelIdentityExt-r17 |

OPTIONAL, -- Cond LCH-SetupModMRB

| | |
|---|---|
| multicastRLC-BearerConfig-r17 | MulticastRLC- |
| BearerConfig-r17 | OPTIONAL, -- Cond LCH-SetupOnlyMRB |
| servedRadioBearerSRB4-r17 | SRB-Identity-v1700 |

```
OPTIONAL -- Need N
    ]]
  }
```

| | |
|---|---|
| MulticastRLC-BearerConfig-r17 ::= | SEQUENCE { |
| servedMBS-RadioBearer-r17 | MRB-Identity-r17, |
| isPTM-Entity-r17 | ENUMERATED {true} |

OPTIONAL -- Need S
}

| | |
|---|---|
| LogicalChannelIdentityExt-r17 ::= | INTEGER (320..65855) |

```
  -- TAG-RLC-BEARERCONFIG-STOP
  -- ASN1STOP
```

logicalChannelIdentity: ID used commonly for the MAC logical channel and for the RLC bearer. Value 4 is not configured for DRBs if SRB4 is configured.

reestablishRLC: Indicates that RLC should be re-established. Network sets this to true at least whenever the security key used for the radio bearer associated with this RLC entity changes. For SRB2, multicast MRBs and DRBs, unless full configuration is used, it is also set to true during the resumption of the RRC connection or the first reconfiguration after reestablishment. For SRB1, when resuming an RRC connection, or at the first reconfiguration after RRC connection reestablishment, the network does not set this field to true. The network does not include this field if servedRadioBearer is set to drb-Identity and the RLC-BearerConfig IE is part of an RRCReconfiguration message contained in ltm-CandidateConfig. For SRB3 and DRBs, network doesn't include this field if the RLC-BearerConfig IE is part of an RRCReconfiguration message associated with subsequent CPAC within the ConditionalReconfiguration IE.

rlc-Config: Determines the RLC mode (UM, AM) and provides corresponding parameters. RLC mode reconfiguration can only be performed by DRB/multicast MRB release/addition or full configuration. The network may configure rlc-Config-v1610 only when rlc-Config (without suffix) is set to am.

servedRadioBearer, servedRadioBearerSRB4: Associates the RLC Bearer with an SRB or a DRB. The UE shall deliver DL RLC SDUs received via the RLC entity of this RLC bearer to the PDCP entity of the servedRadioBearer. Furthermore, the UE shall advertise and deliver uplink PDCP PDUs of the uplink PDCP entity of the servedRadioBearer to the uplink RLC entity of this RLC bearer unless the uplink scheduling restrictions (more ThanOneRLC in PDCP-Config and the restrictions in LogicalChannelConfig) forbid it to do so.

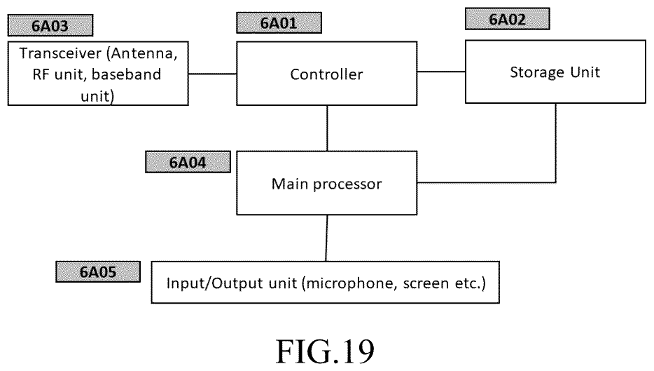

FIG. 19 is a block diagram illustrating the internal structure of a terminal to which the disclosure is applied.

Referring to the diagram, the terminal includes a controller (6A01), a storage unit (6A02), a transceiver (6A03), a main processor (6A04) and I/O unit (6A05).

The controller (6A01) controls the overall operations of the terminal in terms of mobile communication. For example, the controller (6A01) receives/transmits signals through the transceiver (6A03). In addition, the controller (6A01) records and reads data in the storage unit (6A02). To this end, the controller (6A01) includes at least one processor. For example, the controller (6A01) may include a communication processor (CP) that performs control for communication and an application processor (AP) that controls the upper layer, such as an application program. The controller controls storage unit and transceiver such that UE operations illustrated in this disclosure are performed.

The storage unit (6A02) stores data for operation of the terminal, such as a basic program, an application program, and configuration information. The storage unit (6A02) provides stored data at a request of the controller (6A01).

The transceiver (6A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (6A04) controls the overall operations other than mobile operation. The main processor (6A04) process user input received from I/O unit (6A05), stores data in the storage unit (6A02), controls the controller (6A01) for required mobile communication operations and forward user data to I/O unit (6A05).

I/O unit (6A05) consists of equipment for inputting user data and for outputting user data such as a microphone and a screen. I/O unit (6A05) performs inputting and outputting user data based on the main processor's instruction.

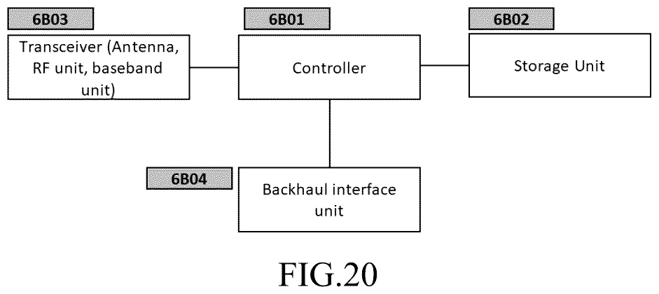

FIG. 20 is a block diagram illustrating the configuration of a base station according to the disclosure.

As illustrated in the diagram, the base station includes a controller (6B01), a storage unit (6B02), a transceiver (6B03) and a backhaul interface unit (6B04).

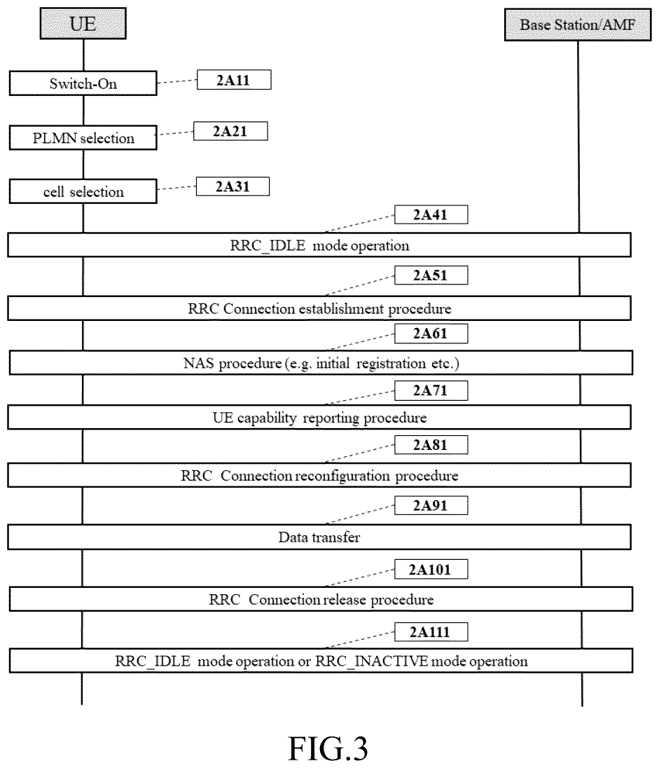

The controller (6B01) controls the overall operations of the main base station. For example, the controller (6B01) receives/transmits signals through the transceiver (6B03), or through the backhaul interface unit (6B04). In addition, the controller (6B01) records and reads data in the storage unit (6B02). To this end, the controller (6B01) may include at least one processor. The controller controls transceiver, storage unit and backhaul interface such that base station operations illustrated in FIG. 3 are performed.

The storage unit (6B02) stores data for operation of the main base station, such as a basic program, an application program, and configuration information. Particularly, the storage unit (6B02) may store information regarding a bearer allocated to an accessed UE, a measurement result reported from the accessed UE, and the like. In addition, the storage unit (6B02) may store information serving as a criterion to determine whether to provide the terminal with multi-connection or to discontinue the same. In addition, the storage unit (6B02) provides stored data at a request of the controller (6B01).

The transceiver (6B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (6B04) provides an interface for communicating with other nodes inside the network. The backhaul interface unit (6B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | PUSCH | Physical Uplink Shared Channel |

What is claimed is:

1. A method performed by a terminal, the method comprising:
receiving from a base station a RRCReconfiguration message that comprises a parameter for delay status report, wherein the parameter for delay status report comprises:
a first threshold associated with a specific logical channel group (LCG); and
a second threshold associated with the specific LCG; and
transmitting to the base station a Medium Access Control (MAC) Control Element (CE) for delay status report in case that a specific condition is fulfilled for the specific LCG,
wherein the MAC CE comprises:
a bitmap related to a plurality of LCGs; and
delay status for the specific LCG, wherein the delay status comprises a first set of delay status fields and a second set of delay status fields, and
wherein:
the first set of delay status fields comprises a buffer size field indicating amount of a first set of data units, wherein the first set of data units are determined based on the first threshold associated with the specific LCG; and
the second set of delay status fields comprises a buffer size field indicating amount of a second set of data units, wherein the second set of data units are determined based on the second threshold associated with the specific LCG.

2. The method of claim 1,
wherein the delay status for the specific LCG further comprises a third set of delay status fields in case that a specific bit of a specific set of bits is set to a first value.

3. The method of claim 1,
wherein the specific condition is fulfilled for the specific LCG in case that:
a specific field related to delay status report is configured for the LCG; and
a specific data unit is buffered for the LCG.

4. The method of claim 3, the method further comprising:
transmitting to the base station a second MAC CE for delay status report in case that a second specific condition is fulfilled for the specific LCG.

5. The method of claim 4,
wherein the second specific condition is fulfilled for the specific LCG in case that:
the specific field related to delay status report is not configured for the LCG; and
the specific data unit is buffered for the LCG.

6. The method of claim 4,
wherein the second MAC CE for delay status report comprises:
the bitmap related to the plurality of LCGs; and
second delay status for the specific LCG, wherein the second delay status comprises the first set of delay status fields and does not comprise the second set of delay status fields.

7. The method of claim 2, wherein:
a presence of the first set of delay status fields for the specific LCG is determined based on a specific bit of the bitmap; and
a presence of the second set of delay status fields for the specific LCG is determined based on the specific set of bits.

8. The method of claim 1, wherein:
the first set of delay status fields further comprises a buffer size table indicator; and
the buffer size table indicator is set to a first value in case that a first buffer size table is used.

9. A terminal in a wireless communication system, the terminal comprising:
a transceiver configured to transmit and receive a signal; and
a controller configured to control the transceiver to:
receive from a base station a RRCReconfiguration message that comprises a parameter for delay status report, wherein the parameter for delay status report comprises:
a first threshold associated with a specific logical channel group (LCG); and
a second threshold associated with the specific LCG, and
transmit to the base station a Medium Access Control (MAC) Control Element (CE) for delay status report in case that a specific condition is fulfilled for the specific LCG,
wherein the MAC CE comprises:
a bitmap related to a plurality of LCGs; and
delay status for the specific LCG, wherein the delay status comprises a first set of delay status fields and a second set of delay status fields, and
wherein:
the first set of delay status fields comprises a buffer size field indicating amount of a first set of data units, wherein the first set of data units are determined based on the first threshold associated with the specific LCG; and
the second set of delay status fields comprises a buffer size field indicating amount of a second set of data units, wherein the second set of data units are determined based on the second threshold associated with the specific LCG.
